(19) United States
(12) Patent Application Publication
(10) Pub. No.: US 2016/0024441 A1
(43) Pub. Date: Jan. 28, 2016

(54) WAX BLEND POLYMER ENCAPSULATES

(71) Applicant: REVOLYMER (U.K.) LIMITED, Deeside, Flintshire (GB)

(72) Inventors: Terence COSGROVE, Deeside (GB); David John DUNCALF, Deeside (GB); Paul Hugh FINDLAY, Deeside (GB); Melanie Jane HUGHES, Deeside (GB); David Alan PEARS, Deeside (GB); Magdalena Agnieszka WARUNEK, Deeside (GB)

(21) Appl. No.: 14/777,343

(22) PCT Filed: Mar. 10, 2014
(86) PCT No.: PCT/GB2014/050710

§ 371 Date: Sep. 15, 2015

(30) Foreign Application Priority Data
Mar. 15, 2013 (GB) 1304667.7

(51) Int. Cl. C11D 3/39; C11D 17/00; C11D 11/00

(52) U.S. Cl. CPC C11D 3/3942; C11D 11/0017; C11D 17/0039

(57) ABSTRACT

A composite including: one or more core units including at least one benefit agent; and a coating on the one or more core units, wherein the coating includes a blend including: at least one wax or wax-like substance; and at least one amphiphilic polymer. Further aspects relate to a process for preparing such composites, and their use in consumer products.

### FIELD OF INVENTION

The present invention relates to the encapsulation of benefit agents, where the benefit agent is a reactive, pro-reactive or catalytic entity that requires protection from other formulation ingredients, but which can be released in response to a particular trigger. This invention also relates to processes for making such encapsulates, as well as their use in products with a wide range of applications.

### BACKGROUND TO THE INVENTION

It will be appreciated that many formulated products contain one or more active ingredients that perform the effect of delivering a desirable effect or benefit. These products may be collectively referred to as active ingredients or benefit agents. Frequently, however, these benefit agents have limitations in that there are difficulties with their compatibility with other formulation components or environmental factors, such as water, air, light, or even adverse reactions with other benefit agents. Traditionally, these incompatibilities have been overcome by formulating the consumer product around the limitations imposed by the benefit agent where possible, or designing packaging such that incompatible components are kept apart. However, to increase consumer convenience and product performance there is an increasing requirement to produce formulations that can withstand environments considered unsuitable for particular benefit agents.

By way of example, it is well established in the field of detergents that certain sensitive benefit agents, such as bleach components, must be protected from incompatible environments by physical separation, for example, by packaging or encapsulation. Consequently laundry and dishwashing products, have traditionally been supplied in solid, powder or granular form or multi layer tablets or multi compartment sachets. In recent times, a shift to liquid forms of product has been seen in the marketplace. However, a significant challenge to the formulator is the reduced chemical stability of functional benefit ingredients in a liquid product as, for example, free water can increase the adverse interactions between incompatible ingredients. Highly reactive benefit agents such as, for example, stain removal or bleaching agents may rapidly degrade or be degraded by components within a liquid formulation. Similarly for solid, powder or granular products, highly reactive benefit agents such as, for example, stain removal or bleaching agents may not be sufficiently stable, even in solid formats, as ingress of atmospheric moisture, humidity or storage in damp conditions can lead to degradation of the product.

Accordingly there is a requirement for a protection system that is able to protect the benefit agents of a formulation under certain conditions. Whilst protection systems such as encapsulation are well known, new protection systems which can provide both acceptable product stability (e.g. an acceptable ‘shelf life’ up to the point of use) and retention of benefit agent activity (e.g. negligible negative interactions between formulation ingredients and/or negligible release of benefit agent(s)) are required. Additionally, whilst retention of benefit agent activity for an extended period of shelf life is clearly essential, it is important that the protection system is also able to release the benefit agent in a usable form and at sufficient chemical and physical concentration at the point of use. Thus, it would be desirable to develop a triggered release mechanism able to protect the benefit agent whilst in storage, but able to release the active on demand when needed. To date, there are no suitable technologies available which incorporate both requirements of protection for enhanced stability and of the release of active on demand, particularly in liquid formulations.

In recent years significant changes have been realised in laundry detergent technology, driven by the leading manufacturers, with a shift from powdered to liquid products in all major geographic markets as well as a shift to lower washing temperatures. However, these liquid products do not include a bleaching system, and therefore their efficacy with respect to stain removal is compromised since the common bleach activators essential for low temperature stain removal are unstable in these formulation media.

The coating and encapsulation of detergent components with various inorganic and organic materials have been widely documented in the art. By way of example, WO 94/15010 (The Proctor & Gamble Company) discloses a solid peroxyacid bleach precursor composition in which particles of peroxyacid bleach precursor are coated with a water-soluble acid polymer, defined on the basis that a 1% solution of the polymer has a pH of less than 7.

Likewise, WO 94/03568 (The Proctor & Gamble Company) discloses a granular laundry detergent composition having a bulk density of at least 650 g/I, which comprises discrete particles comprising from 25-60% by weight of anionic surfactant, inorganic perhydrate bleach and a peroxyacid bleach precursor, wherein the peroxyacid bleach precursor is coated with a water soluble acidic polymer.

U.S. Pat. No. 6,225,276 (Henkel Kommanditgesellschaft auf Aktien) discloses a solid particulate detergent composition comprising a coated bleaching agent that dissolves in water irrespective of pH, a bleach activator coated with a polymeric acid that only dissolves at pH values above 8, and an acidifying agent.

WO 98/00515 (The Proctor & Gamble Company) discloses non-aqueous, particulate-containing liquid laundry cleaning compositions which are in the form of a suspension of particulate material comprising peroxygen bleaching agents and coated peroxygen bleach activators. The coating material is soluble in water, but insoluble in non-aqueous liquids, and is selected from water soluble citrates, sulfates, carbonates, silicates, halides and chromates.

U.S. Pat. No. 6,107,266 (Clariant GmbH) discloses a process for producing coated bleach activating granules in which bleach activator base granules are coated with a coating substrate and are simultaneously and/or subsequently thermally conditioned. The coating substance is selected from C₈-C₃₁ fatty acids, C₈-C₃₁ fatty alcohols, polyalkylene glycols, non-ionic surfactants and anionic surfactants.

EP 0846757 (Unilever NV) discusses the problem of incorporating oxygen bleaches into liquid dishwashing formulations. It refers to Unilever patent U.S. Pat. No. 5,200,236 which describes the coating of water soluble cores with paraffin wax.

U.S. Pat. No. 5,783,540 (Unilever US) discusses the use of paraffin wax (mp 55-70° C.) as a continuous layer coated upon a benefit agent containing core for use in solid powder or tablet dishwashing products in order to provide a rinse benefit

U.S. Pat. No. 5,837,663 (Unilever) discusses the use of paraffin wax (mp 55-70° C.) as a continuous layer which coats a core containing a peracid. Use in dishwashing solid powder or tablet products is particularly described.

U.S. Pat. No. 5,900,395 (Unilever) discusses the use of paraffin wax (mp 35-50° C.) as a continuous layer which coats a core containing a peracid. Use in dishwashing solid powder or tablet products is particularly described.

EP 0436971 (Unilever) specifically describes the application of a single coating of paraffin wax and describes a core composed of a water soluble/dispersible bleach material coated with a continuous waxy coating with a melting point of 40-50° C. The document discusses the problems of incorporating actives in aqueous cleaning compositions.

EP 0510761 (Unilever) describes a core composed of a water soluble/dispersible material coated with a continuous waxy coating with a melting point of 40-50° C. and discusses the problems with incorporating actives in aqueous cleaning compositions. The core may be a bleach, a bleach catalyst, an enzyme, a peracid precursor, a diacylperoxide and a surfactant. The document describes the method of production which is by spray coating using a molten wax in a fluid bed. Applications are primarily for dishwashing products.

WO 95/33817 (Unilever) teaches that dissolution rates, particularly for PAP, from wax encapsulates are often slow. The solution to this problem is to incorporate surfactant into the core. WO 95/33817 also describes the use of a fluid bed to coat cores with molten paraffin wax. Cores may be peroxy acids, diacyl peroxides, peroxygen bleach precursors and mixtures thereof.

WO 95/30735 (Unilever PLC) describes the application of a wax/polyvinyl ether (PVE) coating. The PVE helps to modify the melting behaviour of the coating and improves flowability. Applications include liquid cleaning compositions such as dishwashing, where the particle is stable in alkaline formulation. Cores can include bleaches, both oxygen and chlorine based, or a H₂O₂ generating compound. Cores also include enzymes, proteins and bleach activators. The paraffin melts from between 40-60° C. and coating is achieved by spraying molten wax composition onto the particles.

EP 0596550 and U.S. Pat. No. 5,336,430 (Unilever PLC) describe the use of a structurant to thicken a dishwash formulation. The use of a paraffin wax encapsulated chlorine-based bleach is described.

EP 0533239 (Unilever PLC) describes the problems encountered when a bleach is formulated together with an enzyme in a liquid formulation. The solution to the problem is given by encapsulating the bleach and by incorporating a reducing agent to ‘hold back’ the bleach activity until the enzyme has completed its function. Interestingly it discusses that wax coatings are rendered useless if even a small crack is present in the coating. It describes the application of a single coat of paraffin wax and the encapsulation of a chlorine, bromine or peroxy(acid) bleaches.

U.S. Pat. No. 5,505,875 (Degussa) describes the coating of fine particles of percarbonate with molten wax via a hot ‘fog’ process.

U.S. Pat. No. 7,897,557 (Henkel) utilises a cross-linking reaction to crosslink a polymer coating on a peroxyacid core. Mention is made that the coated particles may further be coated with wax.

WO 2012/140413 (Reckitt Benckiser) discloses a composite core particle which is encapsulated with a pH responsive acrylic polymer and which includes a claim describing a layer of hydrophobic material which can be a wax.

PCT/GB2010/002007 (WO 2011/051681; Revolymer Ltd) describes encapsulation using pH responsive polymers in conjunction with bleach activators. PCT/GB2012/050819 (WO 2012/140438; Revolymer Ltd) describes a similar technology in conjunction with enzymes and PCT/GB2012/050823 (WO 2012/140442; Revolymer Ltd) describes encapsulation with ionic responsive coating materials.

A particular disadvantage of peroxy bleaching benefit agents is their relatively poor stability when stored in the presence of typical detergent components, or in the presence of oxidisable materials such as organic materials which may include waxes and/or organic polymers. Such reactive oxidising agents may become unstable at elevated temperatures and in the presence of material which is readily oxidisable, considerable heat may be generated by reaction between the two. As a result a so-called self-accelerated-decomposition may occur accompanied by a significant exotherm. This is clearly an example of the incompatibility between a benefit agent and other formulation components that is a significant problem for formulators and manufacturers of such peroxy compounds.

Numerous measures have been suggested to improve the stability of oxidizing bleach agents by incorporating stabilizing additives and/or by coating the oxidizing bleach particles with stabilizing layers. For example DE 2,622,610 (Interox) describes the thermal stabilisation of sodium percarbonate by a coating, comprising an inorganic material of sodium sulfate, sodium carbonate and sodium silicate. DE 2,800,916 (Hoechst Aktiengesellschaft) and DE 3,321,082 (Kao Corp) claim protective coatings with compositions containing boron compounds. U.S. Pat. No. 5,858,945 (Lever Brothers) discloses the use of citric acid monohydride as an exotherm control agent for peracids and provides a description of certain exotherm control mechanisms which include for instance loss of water from a hydrated salt. When incorporated into the particles it is claimed these control mechanisms help to remove or reduce any potential exotherm or runaway reaction associated with materials which decompose below the decomposition temperature of the particular peracid. Examples include boric, malic, maleic, succinic and phthalic and azelaic acids.

However, despite the breadth of the above described technologies, an encapsulation system which is able to stabilise highly reactive benefit agents in liquid products whilst still being able to release the beneficial active(s) in a timely response to a trigger stimulus has not yet been developed.

One practical solution to overcome the formulation incompatibility issue is the development of a two compartment liquid product or a multi compartment unit dose sachet, which physically separates the incompatible ingredients (e.g. to give two stable components), which are mixed on dispensing. Such systems have already been introduced to the market. However, such packaging is substantially more expensive than a standard single chamber unit, which combined with the poor consumer feedback, has led to the conclusion that a fully formulated single compartment product must be offered to satisfy the market.

The present invention seeks to provide a composite encapsulated benefit agent which comprises a benefit agent protected physically, for example, from the bulk of other formulation components, by virtue of its encapsulation within a single or multi-layer coating.

### STATEMENT OF INVENTION

A first aspect of the invention relates to a composite comprising:
(i) one or more core units comprising at least one benefit agent; and
(ii) a coating on said one or more core units, wherein said coating comprises a blend comprising:
   (A) at least one wax or wax-like substance; and
   (B) at least one amphiphilic polymer.

A second aspect of the invention relates to a process for preparing a composite as described above, said process comprising applying to one or more core units a coating comprising a blend comprising:
(A) at least one wax or wax-like substance; and
(B) at least one amphiphilic polymer.

A third aspect of the invention relates to a consumer product comprising a composite as described above.

A fourth aspect of the invention relates to the use of a composite or process as described above in the preparation of a consumer product.

A fifth aspect of the invention relates to a method of preparing a consumer product, such as a laundry product, said method comprising admixing a composite according to the invention with one or more conventional consumer product components.

A sixth aspect of the invention relates to the use of a composite as described above as an additive in a laundry product. The laundry product is in liquid or gel format, either as a bulk liquid/gel or in a unit dose format, or may be in a solid powder, tablet or granular format.

Advantageously, the composite of the present invention allows the encapsulated benefit agent to be released under selective conditions. This is achieved by coating or encapsulating the benefit agents, or aggregates of benefit agents, with materials so as to provide (i) a total block to the ingress of water or aqueous solutions by virtue of a polymeric coating layer or layers and, optionally, (ii) a further layer or layers which provide additional protection for the initial layer or layers against attack by formulation ingredients, and/or (iii) further layers which provide thermal stability or exotherm control benefit. The characteristics of the materials, polymer or polymers employed in the coating layers is such that a stimuli response is possible wherein the coating provided by the materials, polymer or polymers, will dissolve or disperse in response to stimuli events such as, for example, upon dilution (for example, an increase in water content or a decrease in surfactant concentration), a change in pH, ionic strength or temperature in order to release the benefit agent.

### DETAILED DESCRIPTION

It is recognised that simply forming a water repellent barrier, around the benefit agent (e.g., by encapsulation of a particle containing a benefit agent with a coating comprising solely a hydrophobic wax, for example), in order to eliminate negative interactions between incompatible ingredients, is not sufficient so as to produce a product capable of effective utility at point of use if the barrier is so complete that release of the active is not possible. Retention of activity (e.g. in storage) and release of benefit agent (i.e. at point of use) are essentially opposing demands on the coating. In the case of highly reactive benefit agents the barrier necessarily needs to be total and complete in order to assure stability of the formulated product and avoid negative interactions between formulation ingredients. However, a total and complete barrier, by itself, may not be capable of release at the point of use.

The present invention relates to encapsulated benefit agents and products comprising such encapsulates, as well as processes for making and using such encapsulates. More specifically, the invention relates to materials and processes employed to make such encapsulated benefit agents which are stable in formulation (e.g. having a suitably long shelf life), but also are able to release their benefit agent payload in response to a particular stimulus. The solution, to this apparent dichotomy, is disclosed herein by the surprising finding that a single or multi-layer encapsulation of a particulate benefit agent(s) provides effective protection of the benefit agent within the core against negative interactions with other formulation ingredients, and, in response to an environmental stimulus the particle is able to release its benefit agent at the appropriate point of use. Within the composite particle described herein, the coating layer or layers work to provide an essentially total barrier to chemical attack and to prevent leakage from the particles' cores (which contains the benefit agent). The coating comprises a blend of materials, optionally in combination with a further layer or layers which provide further protection to the blended coating composition against the tendency of the ingredients present to remove the coating, and which provide for a stimuli triggered release response. Non limiting examples of further layers include inorganic materials, organic materials or polymeric materials.

The coating comprises several components, one of which is a wax or wax-like substance (A), being a hydrophobic wax which may be a synthetic man-made material or may be naturally derived from plant, animal or via extraction from, for example, mining operations and products. The wax or wax-like substance (A) is substantially insoluble in water and, without recourse to theory, provides a substantial block to the transfer of water and other molecules which could react unfavourably with the core composition.

The coating further comprises an amphiphilic polymer (B). Without being bound by theory, it is believed that the amphiphilic polymer (B), present within the wax or wax-like substance (A), provides for a locus of weakness within the waterproof wax or wax-like substance (A) and hence undermines the composite's structure upon the application of a suitable stimulus. The amphiphilic polymer (B) has hydrophobic domains that may be used to give the polymer compatibility with the wax as well as hydrophilic domains that impart the polymer with some degree of solubility or dispersibility in water. When a formulated product containing a benefit agent encapsulated with the coating described herein is used, the environment to which the composite is exposed changes significantly. For instance, this may be observed as a change in the ionic strength, pH, dilution, etc. of the media environment in which the material is stored or applied. The amphiphilic polymer (B) may have a linear, grafted/branched or highly branched structural architecture. The amphiphilic polymer (B) may be further chemically modified by the inclusion of functionality such as acid or basic groups (responsive to pH change), and/or poly(ethylene/propylene oxide) groups (responsive to water activity and/or ionic strength changes) or other chemical functionality which allows for the amphiphilic co-polymer to be dissolved or dispersed when applied to a suitable external stimuli (i.e. upon changing the media from a storage media (the product formulation) to a media which has a differing ionic strength and/or pH and/or dilution and/or surfactant concentration and/or water concentration (the application media)).

The blend produced by mixing the wax or wax-like substance (A) and the amphiphilic polymer (B) generates a material which is able to withstand the negative interactions of the product formulation and hence protect the core active agents but, upon usage, the coating layer is able to dissolve/disperse in a satisfactory time frame in order to release the active agent.

The blend may exist as a single phase solution of the wax or wax-like substance (A) and the amphiphilic polymer (B) or, conversely may exist as a bi- or multi-phase mixture of two or more of the components. It should be realised that the wax or wax-like substance (A) may be in the form of a mixture of waxes or wax-like materials in combination with other materials which need not necessarily be polymeric in nature. In essence, the wax or wax-like substance (A) provides a waterproof barrier and need not be a ‘pure’ material—its purpose is to provide an effective barrier to water and other mobile formulation ingredients and so the main mechanical criterion for the wax or wax-like substance (A) is that it must provide a substantial block to water ingress.

In contrast, the amphiphilic polymer (B), which is present as an intimate component of the blend with the wax or wax-like substance (A), is designed to provide a locus of weakness which is able to dissolve or disperse in response to an environmental stimulus whilst still retaining a barrier property to the ingredients of the formulation prior to any change in environmental stimulus.

The amphiphilic polymer (B) may have similar mechanical properties to the wax or wax-like substance (A) in terms of melting point, hardness, physical state (i.e. liquid or solid), and therefore the amphiphilic polymer (B) may exist as a continuous phase or solution. Conversely, the amphiphilic polymer (B) may have different mechanical properties to the wax or wax-like substance (A) in terms of melting point, hardness, physical state (i.e. liquid or solid), and therefore the amphiphilic polymer (B) may exist as a discrete phase within the blend. The amphiphilic polymer (B) may simply exist within the blend as a solid within a solid or a liquid within a solid (at room temperature) or as a solid solution (at room temperature) in combination with the wax or wax-like substance (A). As stated above, without being limited by theory, it is believed that the amphiphilic polymer (B), present as a mixture with the wax or wax-like substance (A), and having chemical functionality which will give rise to a response to a change in the nature of the media in which the blend finds itself, provides a nucleus for the destabilisation of the blend upon such a change. If, by way of example, the amphiphilic polymer (B) possesses pH sensitive chemical functionality such as a particular level of carboxylic acid functionality and it is then blended into an essentially inert and waterproof material (i.e. wax or wax-like substance (A)) then, depending on its chemical nature and compatibility the blend may be continuous (i.e. a solution) or it may be discontinuous (i.e. a bi- or multi-phase mixture of one material in another). If the blend of these materials is then added to an aqueous media in which the pH may be altered, for example, in the case of a laundry product whereby on application the pH shifts from acid to alkaline (as is common for laundry booster type products) then at low, acidic pH (i.e. in storage in the formulated product), the carboxylic acid groups pertaining to the amphiphilic polymer (B) will be fully protonated and hence will not contribute to any uplift in solubility and so the blend of wax or wax-like substance (A) and amphiphilic polymer (B) will remain intact and capable of providing a strong water proof barrier. However, on application into alkaline wash liquor the carboxylic acid groups present on amphiphilic polymer (B) will now be subject to ionization and hence the amphiphilic polymer (B) will become more soluble within an aqueous environment. This increase in solubility of the amphiphilic polymer (B), which may be present in the wax or wax-like substance (A) as a solution or as a separate phase will now lead to destabilisation of the entire blend, resulting in a triggered release of the payload which the blend is encapsulating. In addition to a change in pH, triggered release can also be occasioned by changes in temperature, dilution, water content, ionic strength, where the amphiphilic polymer (B) is designed accordingly, to respond to these triggers.

### GENERAL DEFINITIONS

As used herein, the term “solid” includes granular, powder, bar and tablet product forms. As used herein, the term “fluid” includes liquid, gel, paste and gas product forms.

In the context of the invention, the term “polymer” may be used to indicate a polymer or copolymer containing one or more monomer constituents which may be randomly arranged within the polymer, or may exist in domains such as is the case for block copolymers, or may exist as branched chains which are arranged in a pendant fashion, or a polymer consisting of monomer units which alternate along the polymer backbone, or a polymer whose architecture is a mixture of two or more of the compositions detailed above.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

### Coating Material

As mentioned above, one aspect of the invention relates to a composite comprising:
(i) one or more core units comprising at least one benefit agent; and
(ii) a coating on said one or more core units, wherein said coating comprises a blend comprising:
   (A) at least one wax or wax-like substance; and
   (B) at least one amphiphilic polymer.

The blend of wax or wax-like substance (A) and amphiphilic polymer (B) coating is insoluble in the product environment and presents an effective barrier to the components of the medium which may include anionic, nonionic and cationic surfactants, active oxygen bleaching agents, water and any other additives. Optionally, the composite may additionally comprise a further coating which may be a responsive polymer coating, which serves to further protect the composite material blend of wax or wax-like substance (A) and amphiphilic polymer (B) from attack by, for example the surfactants present in the formulation media which may degrade the blend. The polymer or polymers as noted above are responsive in nature and whilst insoluble in the product media become soluble when exposed to an environmental stimulus trigger. Trigger environments may include one or more of: dilution (e.g. change in surfactant concentration, change in water concentration), a change in ionic strength, a change in pH, a change in temperature. The composite material blend of wax or wax-like substance (A) and amphiphilic polymer (B) is present so as to provide a barrier to prevent ingress of water into the core of the particle in the formulation environment. Essentially the (inner) core environment is that of a solid dry (active) material which provides for greatest stability of the core material as it would be when maintained in an isolated dry state. Importantly the composite material blend of wax or wax-like material (A) and amphiphilic polymer (B) is responsive to changes in the media. The presence of wax or wax-like substance (A) in the blend provides a waterproof coating which is an excellent barrier to the negative interactions of the formulation ingredients upon the active agents in the core. The presence of a functional material, i.e. responsive amphiphilic polymer (B) in the blend allows the coating to be responsive to changes in the media in which the coated particle finds itself. For example functionalisation of the amphiphilic polymer (B) with acid groups will produce a coating which is insoluble in acid, but becomes soluble as the pH tends towards alkali. Similarly, functionalisation of the amphiphilic polymer (B) with, for example, polyethylene glycol units, results in a coating which becomes soluble as the concentration of water is increased (e.g. upon dilution into water).

One or more well-defined domains in the amphiphilic polymer (B) (e.g. blocks in block copolymers or grafts in graft copolymers) may be chemically similar to the wax or wax-like substance (A) and may therefore be reasonably phase compatible therewith so as to form a continuous solution or, conversely, the amphiphilic polymer (B) may be present as a blend in the wax or wax-like substance (A) as a discrete phase, or amphiphilic polymer (B) may simply be added to the wax or wax-like substance (A) as a finely ground powder so as to form a discontinuous blend. The finely ground powder may, for example be a responsive polymer or a material which is sensitive to changes in ionic strength or water activity as are amphiphilic copolymers with poly(ethylene glycol), poly(vinyl alcohol) blocks or grafts as non-limiting examples.

Preferably, the coating comprises a blend of (A) and (B). More preferably, the blend of wax or wax-like substance (A) and amphiphilic polymer (B) comprises from 1% (A) blended with 99% (B) to 99% (A) blended with 1% (B).

In one particularly preferred embodiment of the invention, the coating comprises a blend of from about 60 to about 90% wax and from about 10 to about 40% of the amphiphilic polymer.

In one preferred embodiment, the composites according to the present invention contain from about 5% to about 75%, preferably from about 10% to about 50% and more preferably from about 15% to about 40% of said blend of wax or wax-like substance (A) and amphiphilic polymer (B) coating by weight of the total composite.

In one preferred embodiment, the composites according to the present invention contain from about 1% to about 75%, preferably from about 10% to about 50% and more preferably from about 15% to about 40% of further optional layer materials, such as primers or fillers or further responsive polymer layers by weight of the total composite.

In one preferred embodiment, the coating layer is present in a thickness of from about 5 μm to about 200 μm, preferably about 8 μm to about 50 μm and most preferably from 15 μm to 40 μm. If the composite comprises additional layers, each of these is present in a thickness of from about 5 μm to about 200 μm, preferably about 8 μm to about 50 μm and most preferably from 15 μm to 40 μm.

In a highly preferred embodiment, at least a portion of the core units are completely encapsulated by the above-described coating. More preferably, substantially all, or all, of the core units are completely encapsulated by the coating layer(s). However, the invention also encompasses composites in which at least a portion of the core units are only partially coated, for example, composites in which at least a portion of the core units are partially coated to a sufficient degree to still exhibit the desired functional characteristics of the invention, namely, so that the coating presents an effective barrier to the remaining components of the medium, but is soluble in the application environment, whereupon the benefit agent will be released.

In one preferred embodiment of the invention, the coating further comprises one or more additional ingredients selected from a plasticiser, a cosolvent, a wetting agent, a compatabiliser, a filler, a dispersant, an exotherm control agent and an emulsifier. These additional ingredients aid film forming, product stability and/or aid the processability of the coating material and may be present as discrete layers or in combination with one or more other components or one or more of the layer forming components described herein.

Suitable plasticisers, cosolvents or compatibilisers for use in the coating include, for example, materials suitable for lowering the plasticity, fluidity or melt profile of the wax. Examples include organic solvents, chlorinated organic solvent, oligomers, terpenes, rosin derivatives, low melting waxes and the like. These materials include, for example, phthalate esters such as diisononyl phthalate; aromatic compounds such as xylene or toluene; chlorinated compounds such as tetrachloroethylene; oligomers such as tetraethylene glycol diheptanoate, oligo(butene) or oligo(propyleneglycol) and waxes such as camphor and compatibilizing polymers such as polybutadiene, polybutene, polyisoprene and polyisobutylene, including copolymers of the foregoing with other diolefins, aliphatic or aromatic olefins and other suitable monomers.

In one highly preferred embodiment of the invention, the coating further comprises a plasticiser, preferably a chlorinated solvent, and wherein plasticiser is present in an amount of from about 0.1 to about 10% based on the weight of the total coating.

Suitable dispersants, wetting agents or emulsifiers for use in the coating include materials capable of stabilising immiscible or insoluble liquids or solids in a continuous phase, for example, detergents or surfactants such as anionic, cationic, zwitterionic or non-ionic surface active compounds including sodium dodecyl sulfate, Sodium lauroyl sarcosinate, cetyl trimethylammonium chloride, N-hexadecyl-N,N-dimethyl-3-ammonio-1-propanesulfonate or polysorbates such as the Tween™ range or surfactants. Additionally dispersants suitable of stabilising hydrophobic or inorganic particulates in an aqueous continuous phase such as the Solsperse® range obtained from Lubrizol or the Disperbyk® range from BYK. Hydrophilic and amphiliphic polymers may be used. Examples include polyvinyl alcohols, polypropylene/polyethylene copolymers and the like.

Suitable fillers for use in the coating include, inert binder or carrier materials which can be inorganic, organic, polymeric or oligomeric. For example, inorganic salts including sulfates, carbonates, chlorides, phosphates, acetates such as sodium sulfate or sodium carbonate or clays, talcs, silicas/silicates or micas may be used. Organic polymeric materials include, for example, polysaccharides, polyamides, poly(vinyl alcohols), poly(ethers), microcrystalline cellulose, functionalised cellulosics such as carboxymethyl, ethyl or propyl cellulose, hydroxymethyl ethyl or propyl cellulose, starch or modified starches.

In one preferred embodiment, the coating further comprises an exotherm control agent. As mentioned above, one disadvantage of peroxy bleaching benefit agents is their relatively poor stability when stored in the presence of typical detergent components, or in the presence of oxidisable materials such as organic materials which may include waxes and/or organic polymers. Such reactive oxidising agents may become unstable at elevated temperatures and in the presence of material which is readily oxidisable, considerable heat may be generated by reaction between the two. As a result a so-called self-accelerated-decomposition may occur accompanied by a significant exotherm.

Surprisingly it has been found that the presence of a layer of modified polyvinyl alcohol, either as a primer layer, i.e. in contact with the peroxy bleach surface, or as a layer at any point in the coating process, such as a ‘top-coat’ or an intermediate layer, affords an effective exotherm control function. It is well known in the literature that polyvinyl alcohol (‘PVOH’), which exists more correctly as a co-polymer of ‘vinyl alcohol’ and vinyl acetate, may be used as a ‘combustion control agent’. It is shown, for example, in Sekisui Specialty Chemicals Publication 2011-PVOH-9030 (which may be found on-line at www.selvol.com) that PVOH is able to gradually decompose when heat is applied to firstly release water and acetic acid (acetic acid is released as a result of the presence of vinyl acetate in ‘PVOH’ which may be present in a greater or lesser extent depending on the degree of hydrolysis of the ‘PVOH’) and then to further decompose in the presence of oxygen to produce carbon dioxide. This gradual decomposition process serves to absorb and to reduce the effect of heating applied upon a substrate.

As previously described, it is generally undesirable to have organic material in the presence of an oxidising material such as a peroxy bleach material. Therefore it is surprisingly that the incorporation of a modified PVOH, which is in its self an organic material, within the composite either as a discrete layer or as a component part of the composite provides for an effective exotherm control agent.

Modified PVOH is described in WO 2004/031271 and WO2009/103576. WO 2004/031271 describes the synthesis and process by which suitable modifications to PVOH may be made in order to produce a modified PVOH film which is resistant to dissolution in concentrated surfactant solution but which dissolves quickly when the surfactant solution is diluted sufficiently. WO2009/103576 also describes how multiple modifications may be made to modify PVOH and further describes how particles may be produced which are coated in this modified PVOH. Whilst mention is made of the utility afforded by coating particles with these modified PVOH materials, these patents do not in any way teach that modified PVOH has the surprising ability to reduce or remove the exotherm or runaway reaction produced as a result of an oxidising agent, such as sodium percarbonate, being in the presence of an oxidisable material, such as an organic material, during a thermal event.

Suitable exotherm control agents include a homopolymer or a copolymer of vinyl alcohol and at least one other monomer. When the exotherm control agent is a copolymer of vinyl alcohol and at least one other monomer, the other monomer(s) preferably contain an alkene group (i.e. carbon-to-carbon double bond) capable of undergoing copolymerisation with vinyl alcohol or a suitable precursor monomer such as a vinyl ester.

In a preferred embodiment of the invention, the exotherm control agent is formed from a copolymer of vinyl alcohol and an olefin, such as ethylene or propylene, preferably ethylene. More preferably, the olefin is present in an amount from about 1 to about 50 mol %, such as from about 2 to about 40 mol %, and most preferably from about 5 to about 20 mol % of the polymer backbone.

In an alternative preferred embodiment of the invention, the exotherm control agent is formed from a copolymer of vinyl alcohol and a alkene-containing monomer, such as a vinylic (e.g. acrylic) or methacrylic monomer. Examples of suitable alkene-containing monomers which may be used in the present invention include, but are not limited to, styrene, acrylonitrile, methacrylonitrile, crotononitrile, vinyl halides, vinylidene halides, (meth)acrylamide, N,N-dimethyl acrylamide, vinyl polyethers of ethylene or propylene oxide, vinyl esters such as vinyl formate, vinyl benzoate or vinyl ethers (such as VeoVa™ 10 available from Momentive™), vinyl ethers of heterocyclic vinyl compounds, alkyl esters of mono-olefinically unsaturated dicarboxylic acids and in particular esters of acrylic and methacrylic acid; vinyl monomers with hydroxyl functionality 2-hydroxy ethyl (meth)acrylate, 2-hydroxy propyl (meth)acrylate, glycerol mono(meth)acrylate, 4-hydroxy butyl (meth)acrylate, hydroxyl stearyl methacrylate, N-methylol (meth)acrylamide; vinyl monomers with additional functionality for crosslinking or adhesion promotion or post functionalisation of the vinyl polymers, such as diacetone acrylamide, aceto acetoxy ethyl (meth)acrylate, glycidyl methacrylate, 2-acrylamido-2-methylpropane sulfonic acid, (meth)acrylic acid, beta carboxy ethyl (meth)acrylate, maleic anhydride, styrene sulfonic acid, sodium sulfo propyl methacrylate, itaconic acid; N,N-dimethyl ethyl amino (meth)acrylate, N,N-diethyl ethyl amino (meth)acrylate, N,N-dimethyl ethyl amino (meth)acrylate, N,N-dimethyl propyl amino (meth)acrylate, N,N-diethyl propyl amino (meth)acrylate, vinyl pyridine, amino methyl styrene, crotonic acid, esters of crotonic acid, crotononitrile, vinyl imidazole; and basic amine monomers can be polymerised as the free amine, protonated salts or as a quaternised amine salt. Where a monomer is indicated with a prefix in brackets (e.g. meth) it shall be understood that it be used in a form with or without the methyl substitution, or alternatively an alternative alkyl group may be present. For example, in the case of acrylic acid, methacrylic acid or another derivative such as ethacrylic acid may be used.

In a preferred embodiment of the invention, the exotherm control agent is a copolymer of vinyl alcohol and an olefin, such as ethylene or propylene, preferably ethylene. More preferably, the olefin is present in an amount from about 1 to about 50 mol %, such as from about 2 to about 40 mol %, and most preferably from about 5 to about 20 mol % of the polymer backbone.

In one highly preferred embodiment of the invention, the coating further comprises an exotherm control agent comprising a homopolymer or copolymer of vinyl alcohol. Preferably this modification introduces an acetal group into the polymer molecule most preferably a ‘butyrated’ modification, wherein the degree of substitution (DS) by the modifying group is from about 0.1 to about 50% and wherein the modified PVOH is present in an amount of from about 0.1 to about 99% based on the weight of the total coating.

A large number of materials are suitable for use in the composite of the invention from synthetic as well as naturally derived sources, including plant and vegetable matter, animal, animal secretions, insect and mineral origin. Further details are presented below.

### Wax or Wax-Like Substance (A)

As mentioned above, the coating on said one or more core units comprises a blend comprising at least one wax or wax-like substance (A) and at least one amphiphilic polymer (B).

The term “wax or wax-like substance” refers to a material which is composed primarily of hydrocarbon groups such as a polymer formed from the polymerisation of alpha-olefins, but may also refer to a natural wax which may contain various types of chemical functionality depending on the source and the natural processes involved in its production. It should be noted that whilst natural waxes contain varied chemical functionality, in general, the degree of functionalisation is not sufficient to make the wax responsive in the manner which is described herein in respect of the amphiphilic polymer (B).

In essence the wax or wax-like substance (A) is a material which is waterproof. This material may preferably be described as a wax, that is to say a material that has some plasticity at normal ambient temperatures and a melting point of above around 30° C. A single wax may be used or a blend of two or more different waxes may be used in the composite.

Waxes are organic compounds that characteristically consist of long alkyl chains. The wax may be a natural wax or a synthetic wax. Natural waxes are typically esters of fatty acids and long chain alcohols. Terpenes and terpene derivatives may also be described as natural waxes. Synthetic waxes are typically long-chain hydrocarbons lacking functional groups.

In one preferred embodiment, the wax is a petroleum wax. Petroleum waxes include, but are not limited to, the following: paraffin waxes (made of long-chain alkane hydrocarbons), microcrystalline waxes (e.g. with very fine crystalline structure), and petroleum jelly. For example, the Bareco Baker Hughes family of microcrystalline waxes are petroleum-derived microcrystalline waxes consisting of complex mixtures of paraffinic, isoparaffinic, and naphthenic hydrocarbons.

Paraffin waxes represent a significant fraction of petroleum and are refined by vacuum distillation. Paraffin waxes are typically mixtures of saturated n- and iso-alkanes, naphthenes, and alkyl- and naphthene-substituted aromatic compounds. The degree of branching has an important influence on the properties.

Other synthetic waxes include, but are not limited to, polyethylene waxes (based on polyethylene), Fischer-Tropsch waxes, chemically modified waxes (for example, esterified or saponified), substituted amide waxes, and polymerized α-olefins. Some waxes are obtained by cracking polyethylene at 400° C. The products have the formula (CH₂)ₙH₂, where n ranges between about 50 and 100. Additionally synthetic waxes may contain chemical functionalisation such as the carboxylated wax VYBAR C6112 produced by Baker Hughes from which it is possible to produce other further functionalisation such as pegylation, by reaction with a suitable mono-, di-, or polyhydric alcohol or alkoxylated also possible, for example, silylation, siliconylisation and the like.

Examples of suitable naturally occurring materials include beeswax, candelilla wax, carnauba wax, paraffin wax, ozokerite wax, ceresine wax, montan wax. Synthetic waxes are also available and examples in this class include microcrystalline waxes such as the Bareco™ range of microcrystalline waxes; the VYBAR™ range of highly branched polymers derived from the polymerisation of alpha olefins; the PETROLITE™ range of polymers and the POLYWAX™ range of polyethylenes.

In one highly preferred embodiment, the wax or wax-like material (A) is selected from the VYBAR™ (Baker Hughes) range of highly branched polymers derived from the polymerisation of alpha olefins and may be a single product chosen from the range or a mixture of two or more products in the range. Particularly preferred is the highly branched synthetic wax VYBAR 260™.

Blends of two or more natural waxes, or two or more synthetic waxes, or blends of one or more natural waxes and one or more synthetic waxes or blends of chemically functionalised synthetic waxes with other synthetic or natural waxes are also suitable for use in the present invention. As will be appreciated by those skilled in the art, such blends can be used to blend the properties of the two together, for instance allowing the melting point of the mixture to be finely tuned. It is also possible that wax or wax-like material (A) may be formed by the mixture of two or more different materials that may not themselves be individually wax like. It can be envisioned that a number of mixtures may be suitable for this purpose such as oils which have been thickened by the addition of metal soaps, clays and polymer additives designed to harden oils and fats such as silica gels, polypropylenes and polyethylenes. As will be appreciated by those skilled in the art, most naturally derived waxes are themselves typically complex mixtures of different chiefly hydrophobic chemical species. It should be appreciated that the foregoing list is not exhaustive but merely illustrative of the range of natural and synthetic waxes available to the formulator. For the purposes of this invention, a particular material may be chosen with the intention of providing a suitable barrier layer for the core particle and having the necessary chemical and physical characteristics such as solubility, melting temperature, barrier properties (i.e. a barrier to reactive species, water and other formulation ingredients), crystalline and/or amorphous properties and hardness which allow for application to the core particle and which provide for an effective barrier.

### Amphiphilic Polymer (B)

As mentioned above, the coating on said one or more core units comprises a blend of at least one wax or wax-like substance (A) and at least one amphiphilic polymer (B).

The purpose of the amphiphilic polymer (B) in admixture with the wax or wax-like material (A) is to provide a locus of weakness when the mixture finds itself in a trigger environment i.e. when the external environment is such that the chemical functionality present in the amphiphilic polymer (B) will respond to the environment and dissolve or disperse, thereby causing the destabilisation of the mixture itself which, when present as a coating, leads to the release of the core material.

The amphiphilic polymer (B) therefore needs to be a material which may be mixed with the wax or wax-like material (A) to produce either a single phase coating or a multiple phase coating or a solid dispersed within the wax or wax-like material (A) and must contain chemical functionality which will respond to an external environment to produce a response in its chemistry.

In one preferred embodiment, the amphiphilic polymer (B) is an amphiphilic copolymer.

As used herein, the term “copolymer” refers to a polymeric system in which two or more different monomers are polymerised together.

As used herein, the term “amphiphilic copolymer” refers to a copolymer in which there are clearly definable hydrophilic and hydrophobic portions.

In one preferred embodiment of the invention the polymer graft is a hydrophilic water soluble polymer that is able to act as the locus of weakness in the coating. For instance it may preferably be a poly(ethylene glycol)/poly(propylene oxide), poly(vinyl alcohol), poly(vinyl pyrrolidone), poly(styrene sulfonate), poly(acrylamidomethylpropylsulfonic acid) or similar molecules. Grafts like poly(ethylene/propylene glycol) are also preferred as they increase the ability of the system to react to changes in ionic strength.

The composite of the present invention may contain one or more amphiphilic copolymers. In one embodiment, the composite of the present invention comprises between about one and about four amphiphilic copolymers, for example one, two, three, or four copolymers, preferably one or two copolymers, most preferably one copolymer.

In one preferred embodiment of the present invention, the amphiphilic copolymer has a hydrophilic-lyphophilic (or hydrophobic) balance (HLB) as measured by Griffin's method of less than or equal to about 15, preferably less than or equal to about 10, more preferably between about 1 and about 10, yet more preferably between about 2 and about 9, for example, between about 3 and about 8. The Griffin method values are calculated by: hydrophilic-lyphophilic balance=20×molecular mass of the hydrophilic portion/molecular mass of the whole molecule.

The molecular mass of the hydrophilic and hydrophobic portions of the polymer can be estimated from the quantities of the relevant monomers put in as feedstocks in the manufacture of the amphiphilic copolymer and based on an understanding of the kinetics of the reaction. The composition of the final product can be checked by comparing the relevant intensities of signals from each block or portion using ¹H nuclear magnetic resonance spectroscopy. Alternatively, other quantitative spectroscopic techniques such as infra-red spectroscopy or ultra-violet visible spectroscopy can be used to confirm the structure, provided the different portions give clearly identifiable and measurable contributions to the resulting spectra. Gel permeation chromatography (GPC) can be used to measure the molecular weight of the resulting materials

As described herein there are available in the marketplace a range of amphiphilic copolymers which have been synthetically modified so as to produce a material which is responsive to a change in chemical environment or media. As used herein, “amphiphilic polymers” are those that have one or more well defined hydrophilic domains and one or more hydrophobic domains. Preferably, the amphiphilic polymer is a copolymer.

A wide range of amphiphilic copolymers may be suitable for use in the invention provided that they contain hydrophobic domains that are sufficient to ensure sufficient compatibility with the wax or wax-like material (A) such that the encapsulates are stable in a formulated product. Any amphiphilic copolymer used in the invention must have sufficient hydrophilic functionality such that the amphiphilic polymer (B) is responsive to changes in the formulation environment. As is well known in the art, in general the structures fall into several different forms of architecture including block copolymers, graft copolymers, highly branched and chain-extended or cross-linked polymers. A person skilled in the art of polymer chemistry would be familiar with such forms, together with methods for their preparation.

Many different polymers are suitable for use in the invention, provided they fulfil the key requirements of an amphiphilic polymer, that is to say they comprise a hydrophobic block that has compatibility with the wax or wax-like material, and a hydrophilic block capable of engineering responsiveness to changes in the environment.

By way of example, polymers comprising polyethylene glycol units, or portions (e.g. blocks or grafts) are particularly suitable for use as amphiphilic polymers in the context of the invention due to their responsive nature to ionic strength and to water activity. Preferably the hydrophilic portions may be based on a poly(alkylene oxide), such as polyethylene oxide or a copolymer thereof. Similarly preferred groups include polyglycidol, poly(vinyl alcohol), poly(ethylene imine), poly(styrene sulfonate) or poly(acrylic acid). Likewise polymers comprising poly(vinyl alcohol) units or portions are also responsive to changes in ionic strength and to water activity.

Particularly useful hydrophobic units or portions are those polymers based on hydrophobic monomers such as olefins (e.g. ethylene, propylene), dienes (e.g. butadiene or isoprene) and ethylenically unsaturated monomers such as isobutylene or octadecene. Aromatic monomers like styrene and alpha-methyl styrene may also be used. In a preferred embodiment, the hydrophobic portion may contain an acid, diacid or anhydride based monomer such as maleic anhydride. Acid and anhydride groups are preferred as they serve as a point of attachment and can potentially increase the responsiveness of the system.

A number of examples of suitable amphiphilic copolymers that have utility in the invention are given below.

Amphiphilic block copolymers may be manufactured by a variety of methods including the sequential addition polymerisation of two or more monomers in a linear manner typically using a living or controlled polymerisation technique. Alternatively they may be produced by the propagation and polymerisation of a polymeric chain from an existing polymer, or by chemically reacting well defined blocks together using coupling or click chemistry. A wide variety of such materials are available commercially and have utility in the invention Many commercial amphiphilic block copolymers materials are produced via the ethoxylation of a preformed alcohol functionalised hydrocarbon block. This hydrophobic block or domain may be, for instance, manufactured by the polymerisation of a hydrophobic monomer, chemical synthesis or processing of petrochemical or natural feedstocks e.g. by the isolation of natural fatty alcohols. The polymerisation of ethylene oxide is then initiated on the alcohol and propagates to form a polyethylene block.

In one highly preferred embodiment the amphiphilic polymer is a block copolymer of ethylene and ethylene oxide. In one highly preferred embodiment the amphiphilic polymer is selected from the range of block copolymers of ethylene and ethylene oxide known as Unithox™ (Baker Hughes) and may be a single product in this range or a mixture of two or more.

Unithox™ polymers are understood to be manufactured by the polymerisation of ethylene oxide (i.e. ethoxylation) from an alcohol functionalised polyethylene wax (which may also be described as a long chain saturated hydrocarbon alcohol). The ratio of PE to PEO in these materials has a profound effect upon their aqueous solution properties and in particular their HLB value (Hydrophilic/Lipophilic Balance) which is a calculation by which a particular amphiphilic material may be classified in terms of its hydrophilicity or hydrophobicity. Importantly, it is possible to identify certain ratios of PE:PEO within the Unithox™ range which, when coated as a layer onto a core particle will show good water-proofing properties when such particles are suspended into a low water containing media. ‘Low water containing’ refers to a liquid media which has approximately less than 20% water—as is often found in unit liquid dose and gel laundry products which may be packaged in dissolvable polymeric sachets. As mentioned above, such particles coated with Unithox™ are water-proof when exposed to a liquid media of low water content. However, the applicant has found that on dilution into water, such as in application usage when, for example, used in a laundry wash, the Unithox™ coating will dissolve/disperse and hence release the active core contents. The applicant has surprisingly found that Unithox™ behaves in a responsive manner to dilution/ionic strength. The applicant has also found that the blending of other hydrophobic materials, such as those described herein as the wax or wax-like material (A), into Unithox™ provides for a coating which has excellent stability, i.e. the active core when coated with a suitable blend of wax or wax-like material (A) and Unithox™ is stable for extended periods in, for example, common commercial laundry products over significant periods of time and particularly products which have low water content (i.e. below around 20% water). Such particles coated, for example, with a suitable blend of water-proof material (e.g. wax or wax-like material (A)) in combination with Unithox™ provides for excellent stability of the active core particles (the ‘payload’) but, due to the responsive nature of the Unithox™ will release the active upon application usage and will do so in a short enough timeframe to be suitable for use in typical household and industrial applications.

As mentioned above Unithox™ are block copolymers of commercially produced ethylene oxide with a hydrophobic (e.g. polyethylene) based block. It will be appreciated that it will be possible to form a similar structure by reacting a functionalised polyethylene material with an appropriately functionalised PEO (PEG) graft. For instance Baker Petrolite supply the Unicid™ range of materials which incorporate carboxylic acid functionality into a polyethylene based polymer wax and the CERAMER™ range—a polyethylene based polymeric material incorporating maleic anhydride functionality. These can potentially be reacted with mono alcohol or difunctional alcohol functionalised PEG resulting in the synthesis of AB or ABA amphiphilic block copolymers respectively.

Amphiphilic graft copolymers can be manufactured by several different methods, for instance a preformed backbone can be reacted with preformed grafts (sometimes called the “grafting to” method). Alternatively, polymerisation can be initiated from a suitably functionalised backbone such that the grafts are generated in situ (“grafting from” approach). Finally, a polymer or oligomer with a polymerisable group (a macromonomer) can be polymerised to yield a graft copolymer in which the original polymer chains are pendant to the backbone (the “grafting through” or macromonomer approach). Amphiphilic graft copolymers suitable for use in the invention typically contain suitable chemical functionality incorporated in the polymer backbone, or pendant to this, or grafted, or present in a random arrangement, or as blocks, or may be subjected to post-production functionalisation. In essence the material must include a hydrophile (X) and also a hydrophobe (Y) in the correct proportions so as to effect the required dissolution properties. Such constructs of X and Y shown in Scheme 1 below will be described in terms of various non limiting and common architectures available.

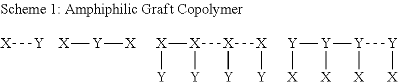

In one embodiment of the invention, the amphiphilic copolymer is a graft copolymer comprising a hydrophobic straight or branched chain carbon-carbon backbone having at least one hydrophilic side chain attached thereto.

In a preferred embodiment of the invention, the hydrophilic side chains of the graft copolymer are each independently of formula (I),

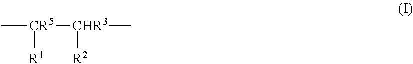

wherein R¹ and R² are each independently H, —C(O)WR⁴ or —C(O)Q;
provided that at least one of R¹ and R² is the group —C(O)Q;
or R¹ and R² together form a cyclic structure together with the carbon atoms to which they are attached, of formula (II)

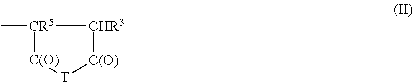

wherein:
R³ and R⁵ are each independently H or alkyl;

### W is O or NR⁴;

Q is a group of formula —X¹—Y—X²P;
T is a group of formula —N—Y—X²—P;

### X¹ is O, S or NR⁴;

### X² is O, S, (CH₂)ₚ or NR⁴;

p is 0 to 6;
each R⁴ is independently H or alkyl;
P is H or another backbone; and
Y is a hydrophilic polymeric group.

As used herein, the term “alkyl” encompasses a linear or branched alkyl group of about 1 to about 20 carbon atoms, preferably about 1 to about 10 carbon atoms, more preferably about 1 to about 5 carbon atoms. For example, a methyl group, an ethyl group, an isopropyl group, a n-propyl group, a butyl group, a tert-butyl group or a pentyl group. In a preferred embodiment of the invention, the hydrophilic polymeric group Y is a poly(alkylene oxide), polyglycidol, poly(vinyl alcohol), poly(ethylene imine), poly(styrene sulfonate), poly(acrylamidomethylpropylsulfonic acid) or poly(acrylic acid). More preferably, the hydrophilic polymeric group Y is a poly(alkylene oxide), such as polyethylene oxide or a copolymer thereof.

In a further preferred embodiment of the invention, the hydrophilic polymeric group Y is of formula -(Alk¹-O)_{b}-(Alk²-O)_{c}—, wherein Alk¹ and Alk² are each independently an alkylene group having from 2 to 4 carbon atoms, and b and c are each independently an integer from 1 to 125; provided that the sum b+c has a value in the range of from about 10 to about 250, more preferably, from about 10 to about 120.

In a further preferred embodiment of the invention, the graft copolymer has from 1 to 5000, preferably from about 1 to about 300, and more preferably from about 1 to about 150, pendant hydrophilic groups attached thereto. For example, the graft copolymer may have between about 1 to about 10, between about 1 to about 5, or between about 2 to about 8 pendant hydrophilic groups attached thereto.

In an alternative embodiment of the invention, the amphiphilic copolymer is a graft copolymer comprising a hydrophilic straight or branched chain carbon-carbon backbone having at least one hydrophobic side chain attached thereto.

Where the amphiphilic copolymer is a graft copolymer, each side chain of the graft polymer preferably has a molecular weight from about 800 Da to about 10,000 Da. For example, each side chain preferably has a molecular weight between about 1000 to about 7,500 Da, between about 2,500 Da to about 5,000 Da or between about 6,000 Da and about 9,000 Da.

In another preferred embodiment of the invention, the amphiphilic copolymer is a block copolymer comprising hydrophilic blocks and hydrophobic blocks in a straight or branched chain carbon-carbon backbone.

In one preferred embodiment of the invention, the straight or branched chain carbon-carbon backbone has at least one side chain attached thereto. The side chain(s) may be hydrophobic or hydrophilic. Examples of suitable side chains include those described above with reference to amphiphilic graft copolymers. Preferably the block copolymer has a straight chain carbon-carbon backbone comprising hydrophilic blocks and hydrophobic blocks. In a further preferred embodiment, the amount of hydrophilic polymer by weight in the final composition is between from about 5 to about 60%.

A graft copolymer is typically produced by the reaction of hydrophilic grafts with a single reactive site on the carbon-carbon backbone, i.e. the reaction uses monofunctional grafts. In order to create a cross-linked or chain-extended copolymer it is necessary to incorporate a hydrophilic graft that has two sites that will react with the carbon-carbon backbone, i.e. a difunctional hydrophilic graft that can act as a cross-linking agent is used.

Preferably, the cross-linked or chain-extended copolymers comprise a linear or branched carbon-carbon backbone and a difunctional graft or a mixture of monofunctional and difunctional grafts. More preferably, the cross-linked or chain-extended copolymers comprise a carbon-carbon backbone functionalized with maleic anhydride or a derivative thereof (as described herein) and an alkylene oxide such as those described in formula (II). Most preferably, the cross-linked or chain-extended copolymers comprise a carbon-carbon backbone derived from polyisoprene or polybutadiene functionalized with maleic anhydride or a derivative thereof, and further comprise hydrophilic grafts, preferably being polyethylene oxide or a copolymer thereof.

In one preferred embodiment of the invention, the carbon-carbon polymer backbone is derived from a homopolymer of an ethylenically-unsaturated polymerizable hydrocarbon monomer or from a copolymer of two or more ethylenically-unsaturated polymerizable hydrocarbon monomers.

More preferably, the carbon-carbon polymer backbone is derived from an ethylenically-unsaturated polymerizable hydrocarbon monomer containing 4 or 5 carbon atoms.

In one highly preferred embodiment of the invention, the carbon-carbon polymer backbone is derived from isobutylene, 1,3-butadiene, isoprene or octadecene, or a mixture thereof.

In one preferred embodiment of the invention, the copolymer comprises a carbon-carbon backbone (e.g. polyisoprene or polybutadiene) onto which maleic anhydride or maleic anhydride acid/ester groups have been grafted. Preferably, the carbon-carbon backbone comprises from about 1 to about 50 wt % maleic anhydride group. As used herein, the term maleic anhydride (MA) group encompasses maleic anhydride, maleic acid and salts thereof and maleic acid ester and salts thereof and mixtures thereof.

The maleic anhydride group coupling chemistry provides a convenient method for attaching the grafts to the copolymer backbone. However, the skilled person would appreciate that other functional groups would be equally effective in this regard.

By way of example, the reaction of another acyl group (e.g. a suitable carboxylic acid or acyl chloride) with a hydroxyl functionalised polymer will be suitable for forming an ester linkage between the graft and backbone. Various strategies for performing coupling reactions, or click chemistry, are also known in the art and may be utilised by functionalising the backbone with suitable groups, possibly in the presence of a suitable catalyst. For instance the reaction of an alkyl or benzyl chloride group on the backbone with a hydroxyl group for instance (i.e. a Williamson coupling), or the reaction of a silicon hydride with an allyl group (a hydrosilyation reaction) could be utilised.

As used herein, the term “aryl” encompasses any functional group or substituent derived from an aromatic ring or a heteroaromatic ring, preferably a C6 to C20 aromatic ring, for example, phenyl, benzyl, tolyl or napthyl.

Preferably, the carbon-carbon backbone comprises from about 1 to about 50 wt % maleic anhydride.

In one preferred embodiment, the backbone of the amphiphilic polymer has a molecular weight from about 1,000 Da to about 10,000 Da.

In another preferred embodiment of the invention, the carbon-carbon backbone is a copolymer of:
(i) maleic anhydride, maleic acid or salts thereof or maleic acid ester or salts thereof or a mixture thereof; and
(ii) one or more ethylenically-unsaturated polymerizable monomers.

The MA group monomer is thus present in the actual backbone rather than pendant to it.

A number of such materials are available commercially, most typically obtained by the radical polymerisation of a mixture of a maleic anhydride group and one or more other ethylenically unsaturated monomers. It will be envisioned that any number of monomers, though most typically a mixture of a maleic anhydride group and one other monomer (to make a bipolymer) or two other polymers (to make a terpolymer) will be used.

Preferably, the maleic anhydride group monomer is maleic anhydride.

Preferably, the other monomer is ethylene, isobutylene, 1,3-butadiene, isoprene, a C10-C20 terminal alkene, such as octadecene, styrene, or a mixture thereof. Most preferably, the other monomer is isobutylene or octadecene.

The percentage of the monomers, and thus functionality in the resulting polymer, may be altered to provide optimal fit to the application. One advantage of backbones prepared by such a method is that they offer the potential for higher loadings of maleic anhydride potentially available for reaction with hydroxy, amine, or sufide functionalised grafts (e.g. suitable PEOs, MPEOs or amine functionalised alkyl ethxoylates like certain Jeffamines).

In one aspect of the invention the backbone is an alternating copolymer prepared by mixing and subsequently polymerising equimolar quantities of a MA group and another monomer.

A particularly preferred backbone copolymer is poly(isobutylene-alt-maleic anhydride) (PIB-alt-MA):

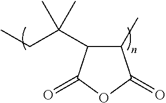

wherein n is between 5 and 4000, more preferably 10 and 1200.

This polymer is available commercially from Sigma-Aldrich and Kuraray Co. Ltd; Kuraray supply the material under the trade name ISOBAM.

A further preferred backbone copolymer is poly(maleic anhydride-alt-1-octadecene) (C18-alt-MA) (available from the Chevron Philips Chemical Company LLC).

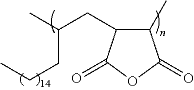

wherein n is between 5 and 500, more preferably 10 and 150.

Chevron Philips make a range of materials (both high and low viscosity) in their PA18 Polyanhydride resins range that are preferred backbones in the invention. PA18 is a solid linear polyanhydride resin derived from 1-octadecene and maleic anhydride in a 1:1 molar ratio.

It will be appreciated by those skilled in the art that a number of other backbones in which maleic anhydride is included in the backbone, either by grafting the maleic anhydride as an adduct, or by copolymerising maleic anhydride with one or more other monomers are useful in the invention.

A range of polybutadiene polymers functionalised with maleic anhydride are sold under the Ricon brand by Sartomer (e.g. Ricon 130MA8) and Lithene by Synthomer (e.g. N4-5000-5MA). A particularly preferred backbone is Lithene N4-5000-5MA. A further particularly preferred backbone is Lithene N4-5000-15MA. A number of useful backbones are also manufactured by Kraton (e.g. Kraton FG) and Lyondell (e.g Plexar 1000 series) in which maleic anhydride is grafted onto polymers or copolymers of monomers such as ethylene, propylene, butylene, styrene and/or vinyl acetate.

Poly(styrene-alt-maleic anhydride) is available from a number of suppliers including Sartomer under the SMA trade name. Poly(ethylene-alt-maleic anhydride) is available from a number of suppliers including Vertellus under the ZeMac trade name. Poly(methyl vinyl ether-alt-maleic anhydride) is available from International Speciality Products under the Gantrez trade name. Poly(ethylene-co-butyl acrylate-co-maleic anhydride) materials can be obtained from Arkema, and are sold under the trade name of Lotader (e.g. 2210, 3210, 4210, and 3410 grades). Copolymers in which the butyl acrylate is replaced by other alkyl acrylates (including methyl acrylate [grades 3430, 4404, and 4503] and ethyl acrylate [grades 6200, 8200, 3300, TX 8030, 7500, 5500, 4700, and 4720) are also available and also sold in the Lotader range. A number of the Orevac materials (grades 9309, 9314, 9307 Y, 9318, 9304, 9305) are suitable ethylene-vinyl acetate-maleic anhydride terpolymers.

In many cases in addition to, or instead of a maleic anhydride functionalised material a derivative of a diacid, mono ester form, or salt is offered. As will be obvious to those skilled in the art many of these are also suitable in the invention.

Similarly, suitable side chains precursors are those discussed below, such as mono methoxy poly(ethylene oxide) (MPEO), poly(vinyl alcohol) and poly(acrylic acid). These may for instance be purchased from the Sigma-Aldrich company. Suitable polyethylene imines are available from BASF under the Lupasol trade name.

In one preferred embodiment, the amphiphilic copolymer is prepared by reacting a compound of formula (III),

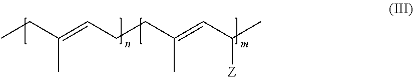

wherein Z is a group of the formula (IV),

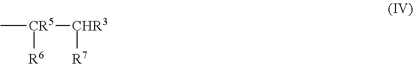

wherein R³ and R⁵ are each independently H or alkyl, and R⁶ and R⁷ are each independently H or an acyl group, provided that at least one of R⁶ and R⁷ is an acyl group, or R⁶ and R⁷ are linked to form, together with the carbon atoms to which they are attached, a group of formula (V),

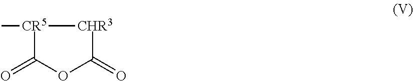

where n and m are each independently an integer from 1 to 20 000. Preferably m is 1 to 1000, more preferably 1 to 100 and yet more preferably 10 to 50. Preferably n is 1 to 5000, more preferably 5 to 2000 and yet more preferably 10 to 1000. Preferably, m is 1 to 100 and n is 5 to 2000.
with a side chain precursor of formula (VI)

HX¹—Y—X²P (VI)

wherein:

### X¹ is O, S or NR⁴;

### X² is O, S, (CH₂)ₚ or NR⁴;

p is 0 to 6;
each R⁴ is independently H or alkyl;
P is H or another backbone; and
Y is a hydrophilic polymeric group.

In one preferred embodiment, the amphiphilic copolymer is prepared by reacting a compound of formula (IIIa),

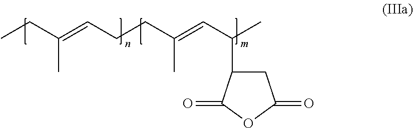

where n and m are as defined above, with a side chain precursor of formula (VI) as defined above.

In one preferred embodiment, the side chain precursor is of formula (Via)

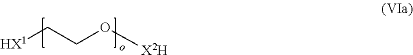

wherein X¹ is O or NH and X² is (CH₂)ₚ and o is an integer from 5 to 250, preferably 10 to 100.

In another preferred embodiment, the side chain precursor is of formula (VIb)

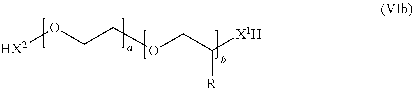

wherein R is H or alkyl, X¹ is O or NH and X² is (CH₂)ₚ and the sum of a and b is an integer from 5 to 600, preferably 10 to 100.

In one particularly preferred embodiment of the invention, the copolymer is prepared by grafting a monofunctional hydrophilic polymer such as poly(ethylene glycol)/poly(ethylene oxide) onto the maleic anhydride residues on the carbon-carbon backbone to form an amphiphilic copolymer of formula (VII),

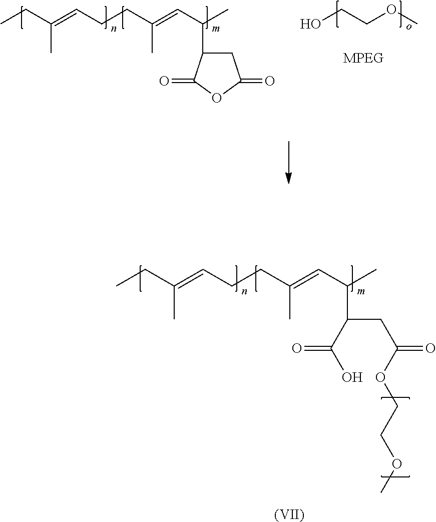

wherein each of m and n is independently an integer from 1 to 20 000. Preferably m is 1 to 1000, more preferably 1 to 100 and yet more preferably 10 to 50. Preferably n is 1 to 5000, more preferably 5 to 2000 and yet more preferably 10 to 1000. Preferably, m is 1 to 100 and n is 5 to 2000. Preferably o is an integer from 5 to 600, preferably 10 to 100.

The above example shows an alcohol functionalized PEO reacting with the maleic anhydride on a PIP-g-MA backbone. Suitable PIP-g-MA backbones are commercially available (for example, LIR-403 grade from Kuraray, which has approximately 3.5 MA units per chain).

Further details on functionalizing polyisoprene with maleic anhydride may be found in WO 06/016179, WO 08/104546, WO 08/104547, WO 09/68569 and WO 09/68570, the contents of which are herein incorporated by reference.

In one preferred embodiment, the copolymer is prepared by adding a ratio of 2:8 equivalents of MPEG with respect to each maleic anhydride (MA) group. This essentially enables complete conversion of the maleic anhydride groups into the PEG functionalized esters.

In another preferred embodiment, the copolymer is prepared by adding a 1:1 ratio of methoxy poly(ethylene oxide) (MPEO) to maleic anhydride. After complete reaction of the MPEO, another (second) (dihydroxy) poly(ethylene oxide) (PEO) of any molecular weight (e.g. 2000, 4000, 6000, 8000 and 10000 Da) can be added. It will be understood by those skilled in the art that MPEO, poly(ethylene oxide) methyl ether, methoxy poly(ethylene glycol) (MPEG), and poly(ethylene glycol) methyl ether are alternative methods of naming the same structure. Similarly PEO is also sometimes referred to as poly(ethylene glycol) (PEG) in the art.

In addition to functionalising unreacted maleic anhydride units, it is also possible to graft PEG or another graft onto the corresponding diacid or a mono ester derivative of MA. This will result in new PEG ester links in the place of the COOH functionality. Two suitable backbones are illustrated below.

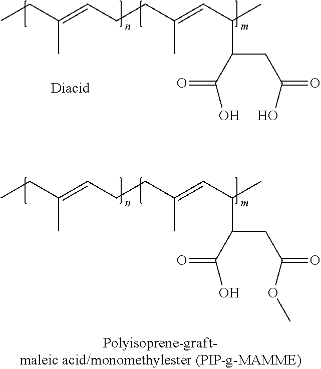

Thus, in one particularly preferred embodiment, the amphiphilic copolymer is prepared by reacting a polymer precursor of formula (IIIb),

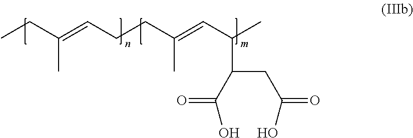

where n and m are as defined above, with a side chain precursor of formula (VI) as defined above.

In another particularly preferred embodiment, the amphiphilic copolymer is prepared by reacting a polymer precursor of formula (IIIc),

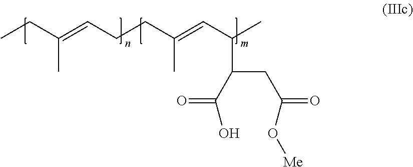

where n and m are as defined above, with a side chain precursor of formula (VI) as defined above.

In an alternative preferred embodiment, the copolymer of the invention is derived from —SH or nitrogen based (NH₂ or NHR) moieties.

In one particularly preferred embodiment, the copolymer comprises an NH₂ functionalized material. Preferably, for this embodiment, the amphiphilic copolymer is prepared from a side chain precursor of formula (VIc)

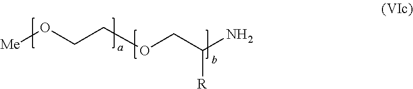

wherein R is H or alkyl, more preferably H or Me, and the sum of a and b is an integer from 5 to 250, preferably 10 to 100.

More preferably, the amphiphilic copolymer is of formulae (VIIIa) or (VIIIb) and is prepared by the following reaction:

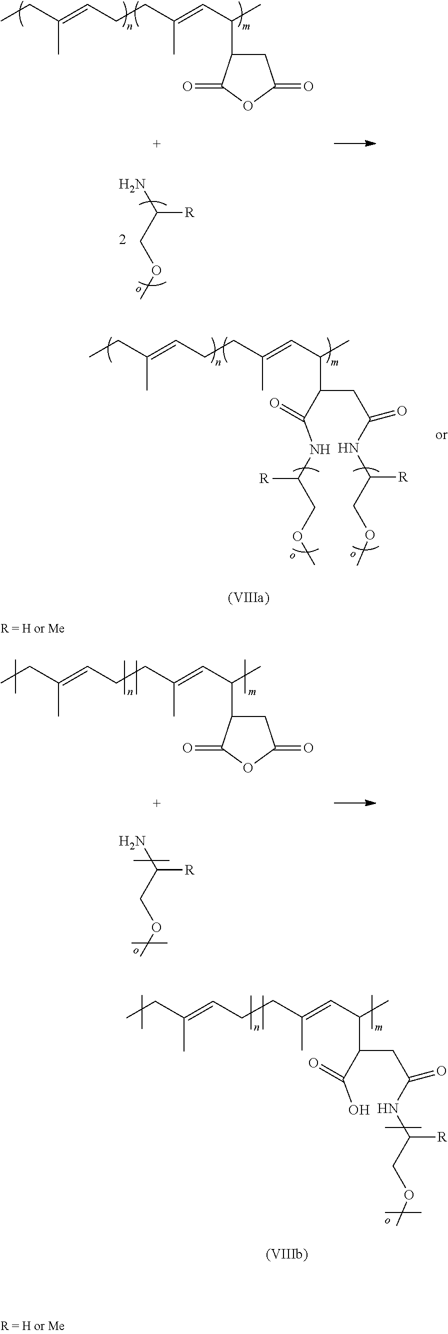

wherein each of m and n is independently an integer from 1 to 20 000. Preferably m is 1 to 1000, more preferably 1 to 100 and yet more preferably 10 to 50. Preferably n is 1 to 5000, more preferably 5 to 2000 and yet more preferably 10 to 1000. Preferably, m is 1 to 100 and n is 5 to 2000. Preferably o is an integer from 5 to 600, preferably 10 to 100.

The NH₂ functionalized material depicted above comprises two grafts on each MA, which is not possible with MPEO. This is due to the greater reactivity of the NH₂ groups compared with OH. In addition to grafting two chains per maleic anhydride unit, the greater reactivity of the NH₂ units with respect to OH leads to a product containing very small quantities of free graft.

In one particularly preferred embodiment of the invention, the amphiphilic copolymer comprises a polybutadiene backbone and pendant hydrophilic grafts attached thereto, wherein each hydrophilic graft is derived from an NH₂ functionalised ethylene oxide and propylene oxide copolymer.

In any of the above embodiments, the compounds of formula (III) may be replaced by compounds of formulae (IX) and (X):

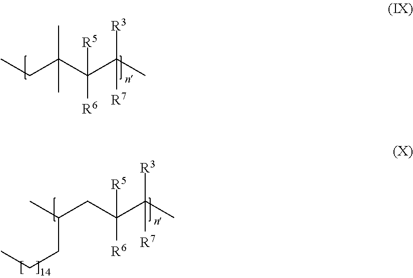

wherein n′ is 5 to 4000 and R³, R⁵, R⁶ and R⁷ are as previously defined.

Similarly, compounds of formulae (IIIa), (IIIb) and (IIIc) in any of the embodiments above may be replaced by compounds of formulae (IXa) or (Xa); (IXb) or (Xb); and (IXc) or (Xc), respectively:

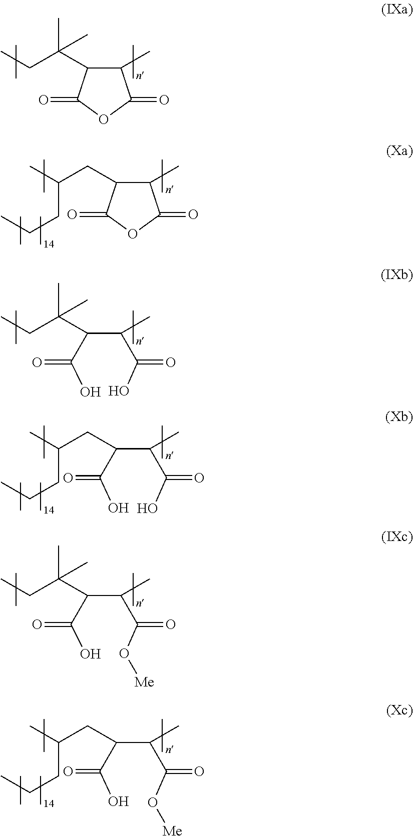

wherein n′ is as defined for compounds of formulae (IX) and (X).

In one preferred embodiment, the hydrophilic groups grafted onto the maleic anhydride groups are polymers of ethylene oxide (i.e. PEOs) copolymerised with propylene oxide. In this embodiment, the amount of propylene oxide is preferably between 1 and 95 mol percent of the copolymer, more preferably between 2 to 50 mol percent of the copolymer, and most preferably between 5 to 30 mol percent of the copolymer.

Preferably, the side chain precursor is of formula,

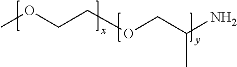

wherein x is 5 to 500, more preferably 10 to 100 and y is independently 1 to 125, more preferably 3 to 30. Preferably, x+y=6 to 600, more preferably 13 to 130. The distribution of ethylene and propylene oxide units may be in the form of blocks as depicted above or as a statistical mixture. In any case the molar ratio of ethylene oxide to propylene oxide in the copolymer will favour ethylene oxide. Such side chain precursors are sold commercially by Huntsman under the Jeffamine brand and Clariant under the Genamin name.

A particularly preferred embodiment is the graft copolymer formed from the reaction of Lithene N4-5000-5MA with the Jeffamine known as M2070. Also a particularly preferred embodiment is the graft copolymer formed from the reaction of Lithene N4-5000-15MA with the Jeffamine known as M2070.

Alternatively, it is possible to use a polymer that has two rather than one functional (e.g. OH, NH₂) units, in which both groups can react with the maleic anhydride. If these maleic anhydride groups are on different backbones, a cross-linked (or network) polymer can be formed. By controlling the ratio of graft to backbone, or by using mixtures with mono-functionalised materials, the degree of cross-linking can be controlled. Thus, it is possible to produce a material that resembles a chain extended graft copolymer (i.e. 2 or 3 graft copolymers) rather than a network by using a mixture of PEO and MPEO which chiefly comprises MPEO.

In one preferred embodiment, the amphiphilic copolymer is prepared from a mixture of PIP-g-MA (polyisoprene with grafted maleic anhydride) together with MPEO (methoxy poly(ethylene oxide) and/or PEO poly(ethylene oxide). Preferably, the MPEO and PEO have a molecular weight of about 2,000 Da.

In one preferred embodiment, the amphiphilic copolymer is prepared from a mixture of PIP-g-MaMme (polyisoprene with grafted maleic monoacid monoester) together with MPEO (methoxy poly(ethylene oxide)) and/or PEO (poly(ethylene oxide)). Preferably, the MPEO and PEO have a molecular weight of about 2,000 Da.

Example methodologies for the manufacture of the graft copolymers may be found in PCT/EP2008/066257 (WO 09/068570), PCT/EP2008/063879 (WO 09/050203) and PCT/EP2008/066256 (WO 09/068569), the teachings of which are incorporated herein by reference.

In an alternative embodiment of the invention, the amphiphilic copolymer is a cross-linked/network (or chain-extended) copolymer. Copolymers of this type may be prepared using the same or similar carbon-carbon polymer backbones to those described above in respect of amphiphilic graft copolymers. In one embodiment of the invention, the amphiphilic copolymer is a cross-linked/network copolymer comprising a hydrophobic straight or branched chain carbon-carbon backbone having at least one hydrophilic side chain attached thereto.

### Modified PVOH

According to one opreferred aspect of the present invention, the functionalised vinyl alcohol homopolymer or copolymer of the type described above can be prepared by a process comprising the steps of:
a. preparing a straight or branched chain homopolymer of vinyl acetate or a copolymer of vinyl acetate with at least one other monomer;
b. hydrolysing the homopolymer or copolymer of vinyl acetate obtained in step (a) to obtain a homopolymer or copolymer of vinyl alcohol;
c. reacting the homopolymer or copolymer of vinyl alcohol obtained in step (b) with a suitable aldehyde to obtain an acetal functionalised homopolymer or copolymer of vinyl alcohol comprising one or more reactive coupling groups;
d. optionally isolating the copolymer formed in step c.

The polymer obtained upon completion of each reaction detailed in steps (a) to (b) of the above process may be isolated prior to initiation of the following step or reacted in situ.

According to one preferred embodiment of step (a) of the above process, vinyl acetate is reacted with at least one other monomer to obtain a straight or branched chain vinyl acetate copolymer. Thereafter, according to step (b), the copolymer of vinyl acetate is hydrolysed to obtain a copolymer of vinyl alcohol. By way of example, ethylene may be copolymerised with vinyl acetate to afford an ethylene-vinyl acetate copolymer, which may be subsequently hydrolysed to form an ethylene-vinyl alcohol copolymer (EVOH), as follows:

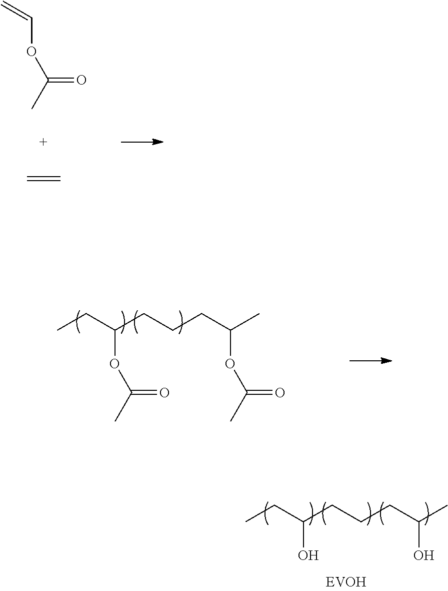

Alternatively, according to another preferred embodiment of step (a) of the above process vinyl acetate is polymerised to obtain a straight or branched chain vinyl acetate homopolymer, i.e. poly(vinyl acetate). Thereafter, according to step (b), the homopolymer of vinyl acetate is hydrolysed to poly(vinyl alcohol), as follows:

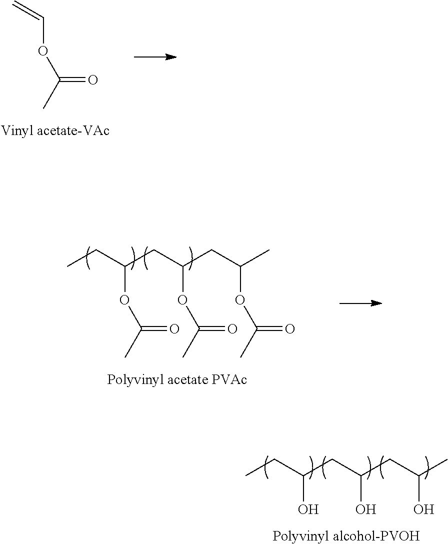

It will be appreciated that PVOH may also be prepared by the hydrolysis of other poly(vinyl esters) such as poly(vinyl formate), poly(vinyl benzoate) or poly(vinyl ethers). Similarly a copolymer of vinyl alcohol such as EVOH may also be prepared by copolymerising the relevant monomer with a vinyl ester other than vinyl alcohol and hydrolysing the resulting polymer for instance. Such polymers are also within the scope of the present invention.

In addition it may be envisioned that the PVOH based copolymer may comprise a block, graft or network polymer in which the PVOH forms a block or as grafts to, or from, another polymer or copolymer backbone or as a branched polymer containing short, oligomeric or polymeric cross-links within the polymeric or co-polymeric structure as a whole. A degree of cross linking may be beneficial in order to maintain structural integrity of the coated layer as well as to increase the barrier properties of the layer. Cross linking may be carried by any suitable technique which are well known and may include the use of agents such as epoxides, formaldehyes, isocyanates, reactive siloxanes, anhydrides, amidoamines, boric acid and suitably reactive transition metals and derivatives thereof.

It will be appreciated that during step (b) of the process, a number of the vinyl acetate groups present may remain unhydrolysed in the resulting polymer. In a preferred embodiment of the invention, step (b) comprises partial hydrolysis of the homopolymer or copolymer of vinyl acetate; for example, between about 25 and about 100 percent hydrolysis, more preferably between about 50 and about 100 percent hydrolysis, yet more preferably between about 60 to about 100 percent hydrolysis, and most preferably between about 88 to about 100 percent hydrolysis.

Preferred homo and copolymers of vinyl alcohol have average molecular weights ranging from 1000 to 3000000, more preferably 1000 to 300000 which provide for aqueous solutions which are easily handled. As described earlier the description PVOH will include copolymers containing polyvinyl acetate monomers at varying degrees according to the degree of hydrolysis of the PVOH.

Preferred modified PVOH materials may be produced via the reaction of a suitable aldehyde directly with the ‘vinyl alcohol’ functionality of the parent PVOH based homopolymer or copolymer. Suitable aldehydes include: straight and branched chain alkyl aldehydes containing a branched or linear C4 to C22 carbon chain, acetals, ketals, esters, epoxides, isocyanates, suitably reactive oligomers, polymers and aromatic compounds.

The degree of modification of the PVOH based homopolymer or copolymer is preferably from about 1% to about 50%; by this it is meant that the ‘OH’ portion of the PVOH has been replaced by the given percentage. The person skilled in the art will appreciate that, for example, in the case of the reaction of an aldehyde with ‘PVOH’ for each molar quantity of aldehyde two molar quantities of ‘OH’ are substituted via the acetalation reaction. Hence a 50% modified PVOH will have been reacted with 25% of a suitable aldehyde, and, of course the degree of hydrolysis of the PVOH will dictate the maximum level of substitution possible.

### Additional Layers

In one preferred embodiment, the composite further comprises one or more additional layers. Preferably, the composite comprises one or more additional coating layers which may be inorganic, organic or polymeric.

In one preferred embodiment, the additional layer is, for example, a single responsive polymer or mixtures of such polymers.

For example, in one embodiment the composite comprises a further layer of responsive polymer or other responsive material, which is applied to the blend of wax or wax-like material (A) and amphiphilic polymer (B) coated onto the core particles.

As used herein the term “responsive polymer” refers to a polymer that retains its structural integrity within the product format (formulation), but which responds to a particular trigger, for example, a change in pH, temperature, ionic concentration or the like.

Suitable responsive polymers include, but are not limited to, those based on ethylene glycol or polyvinyl alcohol mentioned above, and disintegrate in response to a trigger stimulus which may take the form of a change in pH, of temperature, of ionic strength or of dilution. By way of example, suitable pH-responsive polymers for the additional layer are described in WO 2012/140438 (Revolymer Limited). Suitable ionic-strength responsive polymers for the additional layer are described in WO 2012/140442 (Revolymer Limited).

The entire layers or layer structure may, optionally, contain other materials and/or layers which fulfil functions such as provision of primer layer(s) or filler(s) or other material(s) which provide(s) a particular function not necessarily related to providing a response to stimulus or stimuli. The optional further layer of responsive polymer(s) or other responsive material(s) may be required in order to protect the blend of wax or wax-like material (A) and amphiphilic polymer (B) layer from components in the product formulation which may be able to dissolve or disperse the blend, or the extra layers may be required to provide an inter-layer or core-layer adhesive effect or may simply be binders, fillers, coloured materials or primers.

In one preferred embodiment, the additional layer is a primer layer, a filler layer, an anticaking agent or flow aid incorporated as a layer or an adhesion promoting layer, or a combination thereof.

For example, further optional layers may comprise materials whose function is to provide a primer layer or layers in order to give greater compatibility and/or adhesion between chemically dissimilar layers. Primer layers may be applied at any level within the layers and may be directly applied to or within the core or cores. Further optional layers may be present such as filler materials or anticaking/anti-adhesion agents which may be inorganic or organic in chemical nature and may be present in a functionally neutral capacity (e.g. non-responsive to external stimuli) so as to adjust, as non-limiting examples, the density or the correct ratio of components within the composite particle.

In one preferred embodiment, the process of the invention comprises applying a blend of the wax or wax-like material (A) and amphiphilic polymer (B) to the core particle or particles, followed by the application of a further coating layer which may include a responsive polymer layer. The application of other layers can be before or after the blend of wax or wax-like material (A) and amphiphilic polymer (B). For example, in one preferred embodiment, a primer or primer layers, or a filler or filler layers, is applied directly to the core surface, or on top of other layers including those of the blend of the blend of wax or wax-like material (A) and amphiphilic polymer (B), or the optional further responsive polymer layer.

In one preferred embodiment, the composite comprises an additional layer which comprises an exotherm control agent, Suitable exotherm control agents are described hereinabove. In one highly preferred embodiment, an additional layer of modified PVOH may be applied at any point, either as an initial primer layer which is in intimate contact with the outer surface of the benefit agent core or it may be placed at any point within the total coating layer. As described herein this modified PVOH layer provides utility as an anti-tack layer but also has an exotherm control property which is necessary when the benefit agent is a reactive material, for example, an oxidising agent, where the potential for reaction with the organic waxes and polymers present in the coating is a possibility. This layer described above may be applied separately or where other layers are applied from an aqueous dispersion or aqueous emulsion it is possible to dissolve the modified PVOH into the aqueous phase of the dispersion or emulsion and hence apply the material in combination with another layer. As described earlier many manufacturers of oxidising bleaches, such as sodium percarbonate, have utilised an external coating of an inorganic salt such as sodium sulfate in order to provide for an exotherm control.

### Consumer Product

Another aspect of the invention relates to a consumer prdduct comprising a composite as described above. The consumer product may be a product for the care of homes, businesses or institutions for instance in laundry or dishwash products and detergents, particularly preferably liquid detergents. Other preferred examples of consumer products include personal care and cosmetic formulations, surface cleaning formulations, pharmaceutical, veterinary, food, vitamin, mineral and nutritional compositions. Further preferred examples include compositions for use in agriculture and a range of industries including mining and manufacturing, for instance in the production of food, flavours, fragrances and beverages or for use in areas such as lubrication aids, oil field technology, fuel additives, dyes and pigment technology, laundry softening—including laundry actives and polymeric ingredients—textile lubricants, softening agents, enzymes, whitening agents and shading dyes.

Consumer products include those relating to baby care, beauty care, fabric and home care, family care, feminine care, or devices generally intended to be used in the form in which it is sold. Such products include, but are not limited to, diapers, bibs, wipes; products for and/or methods relating to treating hair (human, dog, and/or cat), including, bleaching, colouring, dyeing, conditioning, shampooing, styling; deodorants and antiperspirants; personal cleansing; cosmetics; skin care including application of creams, lotions, and other topically applied products for consumer use including fine fragrances; and shaving products, products for and/or methods relating to treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; vitamin products: including tablets, soft and hard capsules, gel and liquid formats and containing vitamins or other benefit agents which require stabilisation due to adverse interaction with other formulation ingredients or natural processes such as instability to oxidation; agrochemical products which include: products or formulations containing herbicides, fungicide, insecticides, plant or insect hormones or growth regulators or fertilizers such products requiring stabilisation of the benefit agent to prevent degradation of the benefit agent due to negative interactions with formulation ingredients or to prevent degradation due to adverse chemical reactions which result in a reduction of activity of the benefit agent over time when in formulation; pharmaceutical products, whereby a benefit agent may require stabilisation in order to avoid degradation caused by adverse interactions with other formulation ingredients or to prevent degradation from chemical reactions such as, for example, oxidation. Pharmaceutical product formats may take the form of powders, granules, capsules both hard and soft, such capsules may even be engineered to release at a particular location with the human body such as, for example, an enteric polymer capsule designed to survive the environment of the stomach and to be able to release within the gut. Other formats may include liquids, gels or pastes; Veterinary products whereby benefit agents may be protected from adverse reactions with other formulation ingredients to provide stable products which are able to deliver activity during application usage. Veterinary Product formats may take the form of powders, granules, capsules both hard and soft, such capsules may even be engineered to release at a particular location with the body such as, for example, an enteric polymer capsule designed to survive the environment of the stomach and to be able to release within the gut. Other formats may include liquids, gels or pastes

In one preferred embodiment, the consumer product is a cleaning and/or treatment composition. As used herein, the term “cleaning and/or treatment composition” is a subset of consumer products that includes, unless otherwise indicated, beauty care, fabric and home care products. Such products include, but are not limited to, products for treating hair (human, dog, and/or cat), including, bleaching, colouring, dyeing, conditioning, shampooing, styling; deodorants and antiperspirants; personal cleansing; cosmetics; skin care including application of creams, lotions, and other topically applied products for consumer use including fine fragrances and shaving products, products for treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, including those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners including toilet bowl cleaners; hair shampoos and hair-rinses; shower gels, fine fragrances and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists all for consumer or/and institutional use; and/or methods relating to oral care including toothpastes, tooth gels, tooth rinses, denture adhesives, tooth whitening.

In one highly preferred embodiment, the consumer product is a laundry product.

In another preferred embodiment, the consumer product is a fabric and/or hard surface cleaning and/or treatment composition. As used herein, the term “fabric and/or hard surface cleaning and/or treatment composition” is a subset of cleaning and treatment compositions that includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, including those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners including toilet bowl cleaners; and metal cleaners, fabric conditioning products including softening and/or freshening that may be in liquid, solid and/or dryer sheet form; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists. All of such products which are applicable may be in standard, concentrated or even highly concentrated form even to the extent that such products may in certain aspect be non-aqueous.

In a preferred embodiment of the invention the composite of the invention is suitable for inclusion in a liquid consumer product as a coated suspension, the coating of which is readily soluble or dispersible in the application environment, whereupon the benefit agent(s) will be released.

### Benefit Agent

The composites of the invention comprise one or more core units comprising a benefit agent. As used herein, the term “benefit agent” includes any agent that is a reactive, pro-reactive or catalytic entity that requires protection from other formulation ingredients.

In one preferred embodiment, the benefit agent is a bleach or bleach system.

In one particularly preferred embodiment the benefit agent is a bleach activator; said bleach activator comprises a material selected from tetraacetyl ethylene diamine (TAED); benzoylcaprolactam (BzCL); 4-nitrobenzoylcaprolactam; 3-chlorobenzoylicaprolactam; benzoyloxybenzene-sulfonate (BOBS); nonanoyloxybenzenesulfonate (NOBS); phenyl benzoate (PhBz); decanoyloxybenzenesulfonate (Cio-OBS); benzoylvalerolactam (BZVL); octanoyloxybenzenesulfonate (C8-OBS); perhydrolyzable esters; 4-[N-(nonaoyl) amino hexanoyloxy]-benzene sulfonate sodium salt (NACA-OBS); dodecanoyloxybenzenesulfonate (LOBS or C12-OBS); 10-undecenoyl-oxybenzenesulfonate (UDOBS or Cn-OBS with unsaturation in the 10 position); decanoyloxybenzoic acid (DOBA); (6-octanamidocaproyl)oxybenzenesulfonate; (6-nonanamidocaproyl) oxybenzenesulfonate; (6-decanamidocaproyl)oxybenzenesulfonate and mixtures thereof.

In another particularly preferred embodiment the benefit agent is a preformed peracid; said preformed peracid comprises a material selected from the group consisting of peroxymonosulfuric acids; perimidic acids; percabonic acids; percarboxilic acids and salts of said acids; preferably said percarboxilic acids and salts thereof comprise phthalimidoperoxyhexanoic acid, 1,12-diperoxydodecanedioic acid; or monoperoxyphthalic acid (magnesium salt hexahydrate); amidoperoxy acids, preferably said amidoperoxyacids comprises N,N′-terephthaloyl-di(6-aminocaproic acid), a monononylamide of either peroxysuccinic acid (NAPSA) or of peroxyadipic acid (NAPAA), N-nonanoylaminoperoxycaproic acid (NAPCA), and mixtures thereof; d) said diacyl peroxide comprises a material selected from the group consisting of dinonanoyl peroxide, didecanoyl peroxide, diundecanoyl peroxide, dilauroyl peroxide, dibenzoyl peroxide, di-(3,5,5-trimethyl hexanoyl) peroxide and mixtures thereof.

In another particularly preferred embodiment the benefit agent is a hydrogen peroxide source. Preferably, said hydrogen peroxide source comprises a material selected from the group consisting of a perborate, a percarbonate, a peroxyhydrate, a persulfate and mixtures thereof;

In one particularly preferred embodiment, the benefit agent is sodium percarbonate.

In another preferred embodiment the benefit agent is an enzyme. Preferably, said enzyme comprises a material selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

In one highly particularly preferred embodiment, the benefit agent is selected from a lipase, protease, amylase, cellulase, pectatase, lyase, xyloglucanase and mixtures thereof.

In one preferred embodiment the benefit agent is a vitamin, essential oil, or other oil of nutritional benefit such as those from fish and vegetable sources. Suitable examples include marine oils (including “fish oils”) which are oils that are obtained from aquatic lifeforms, either directly or indirectly, particularly from oily fish. Marine oils include, for example, herring oil, cod oil, anchovy oil, tuna oil, sardine oil, menhaden oil and algae oil. Such oils may be desirable as sources of nutritive agents such as omega-3, omega-6 and omega-9 fatty acids docosapentaenoic acid, eicosatetraenoic acid, moroctic acid and heneicosapentenoic acid.

In another preferred embodiment the benefit agent is a drug or pro-drug.

In another preferred embodiment the benefit agent is an agent for the treatment of human skin such as one intended to treat acne (e.g benzoyl peroxide) or the signs of aging (e.g. botulinum toxin).

In a further preferred embodiment the benefit agent is a biocide or bacteriostat for the cleaning and disinfection of manufacturing equipment used in the preparation of consumer products for the food and beverage industry.

In another preferred embodiment, the benefit agent is a herbicide, insecticide, fungicide, fertiliser, plant growth regulator or a mixture of the aforementioned benefit agents which may be used in agrochemical applications whereby an active is required to be kept in a stable condition until it is required for release upon application.

In one preferred embodiment, the benefit agent is in particulate form.

In another preferred embodiment, the benefit agent is in granulate form. For this embodiment, preferably the benefit agent is combined with a granulating polymer or binder.

The benefit agent may be processed to form core particles. This may be via granulation, compaction, pelletizing or extrusion and spheronisation. The benefit agent may be mixed with fillers, binders or disintegrants, or a mixture thereof. The benefit agent may also be mixed with further optional ingredients as desired. Fillers are selected upon their ability to absorb and retain water in order to achieve the optimal rheological conditions for lubrication and surface plasticization required during extrusion and spheronisation.

A non-limiting list of suitable fillers include, saccharides and their derivatives, disaccharides such as sucrose, polysaccharides and their derivatives such as cellulose or modified cellulose such as microcrystalline cellulose, sugars such as mannitol, cyclic oligosaccharides such as β-cyclodextrin and synthetic polymers such as polyvinylpyrrolidone (PVP) and crosspovidone (Crosslinked PVP). Crosspovidone is particularly preferred. A particularly preferred source of Crosspovidone is Kolloidon CL-M, a micronized product.

Binders may be used to ensure that the particles can be formed with the required mechanical strength of the end product. A non-limiting list of suitable binders include, anionic surfactants such as secondary alkyl sulfonate sodium salts, nonionic surfactants such as alcohol ethoxylates based on C12/C15 oxo alcohol, saturated fatty acids such as lauric acid, and synthetic polymers such as polyacrylate copolymers and polyvinyl alcohol (PVOH). Particularly preferred binders comprise the secondary alkyl sulfonate sodium salts, in particular Hostapur SAS from the group of anionic surfactants.

Any binders or fillers that are compatible with the bleaching materials may be used individually or in combination to form the particles of the present invention.

Additional ingredients may be added prior to particle formation to provide additional stability, for example chelating agents such as etidronic acid to bind metal ions that prove detrimental to the stability of the bleach material.

In one preferred embodiment, the consumer product comprises from about 0.001% to about 15%, preferably from about 2% to about 12%, and more preferably from about 4% to about 10% of the composite described herein by weight of the total composition.

In one highly preferred embodiment of the invention:

the benefit agent is sodium percarbonate;
the coating comprises a blend of from about 60 to about 90% wax and from about 10 to about 40% of the amphiphilic polymer;
the wax is a polyolefin polymer, preferably Vybar 260; and
the amphiphilic copolymer comprises a polybutadiene backbone and pendant hydrophilic grafts attached thereto, wherein each hydrophilic graft is derived from an NH₂ functionalised ethylene oxide and propylene oxide copolymer.

### Preparation of Blend

As described above the wax or wax-like substance (A) and the amphiphilic polymer (B) may be blended together to form a homogenous mixture (i.e. a single phase blend) or they may be blended together to form a mixture of two or more phases. The phases present may be as a liquid in a solid or as a solid in a liquid or as a solid in a solid. Such blended materials may be produced by melting the two or more materials together to form a homogenous blend or, as described above, as a mixture of two or more phases.

Alternatively the two or more materials may be dissolved together to form a solution with any suitable solvent and then applied to the core by, for example, spray application or other suitable application method. Upon drying of this spray solution the blended mixture may then remain as a single phase dry coating or may phase separate to produce a dry coating which is multiphasic (two or more phases) as described above.

Alternatively a blended mixture of the wax or wax-like substance (A) and the amphiphilic polymer (B) may be produced by adding a solid material, such as a synthetic polymer, which has been finely ground (amphiphilic polymer (B)) so as to produce a ‘slurry’ of the dry powdered polymer within the matrix of the wax or wax-like substance (A), which may be heated to produce a molten mixture, or the two materials (or more) may be added to each other using a suitable solvent to dissolve either the wax or wax-like substance (A), or both the amphiphilic polymer (B) and the wax or wax-like substance (A). The polymer so added may not necessarily be a solid at room temperature and may well be a liquid or a viscous liquid and it may be mixed as described above either in the molten wax or wax-like substance (A), or in solution.

### Coating Process

A further aspect of the invention relates to a process for preparing a composite as defined above, said process comprising applying to one or more core units a coating comprising a blend of:
(A) at least one wax or wax-like substance; and
(B) at least one amphiphilic polymer.

In one preferred embodiment, the blend of wax or wax-like substance (A) and amphiphilic polymer (B) is applied directly to the one or more core units.

In another preferred embodiment, the blend of wax or wax-like material (A) and amphiphilic polymer (B) is applied to a primer or filler layer, which itself has been applied to the surface of said one or more core units.

A further aspect of the invention relates to a process for preparing a composite particle as defined above, said process comprising applying a further responsive polymer coating after the composite material blend has been applied to said one or more core units.

In one preferred embodiment, the core units are prepared by co-agglomerating a granulating or binding agent with the benefit agent in order to produce suitably sized particle cores prior to coating the core units with the layers composing the composite material blend the optional responsive polymer and optionally primer and/or filler layers.

In one preferred embodiment, the core units are prepared by spheronisation of the benefit agent in order to produce suitably sized particle cores prior to coating the core units.

Production of core particles may be carried out by any suitable means and the method is not critical to the invention save that the produced cores must be of sufficient mechanical strength to ensure that the particles are not damaged, broken up or otherwise degraded by the coating process employed.

Encapsulation may be carried out by any suitable means and the method is not critical to the invention. For example, the coating material may be sprayed on as a molten material or as a solution or dispersion in a solvent/carrier liquid which is subsequently removed by evaporation. The coating material can also be applied as a powder coating e.g. by electrostatic techniques, although this is less preferred as the adherence of powdered coating material is more difficult to achieve and can be more expensive. If layer coatings are applied in particle form (such as powders or dispersions), it may also be necessary to coalesce the particles which make up each layer in order to produce a layer which is sufficiently coherent, without appreciable levels of flaws such as cracks, holes or ‘flakiness’, to produce a sufficiently effective barrier.

Molten coating is a preferred technique for coating materials of melting point <80° C. but is less convenient for higher melting points (i. e. >100° C.). For coating materials of melting point >80° C., spraying on as a solution or dispersion is preferred. Organic solvents such as ethyl and isopropyl alcohol or chloroform can be used to form the solutions or dispersions depending on the nature and solubility of the solute, although this will necessitate a solvent recovery stage in order to make their use economic.

Application, in the case of waxes and/or other hydrophobic materials, from the molten state is particularly advantageous as this method allows for the potential for the direct application of up to 100% solids and avoids complications such as solvent recovery, allowing time for drying and the issues associated with the safe handling of volatile and potentially flammable solvents.

Application from solvent solution(s) is advantageous as the coating materials may be applied as a continuous and homogenous film from solvent solution. Any suitable solvent may be used accepting that consideration for volatility, boiling point, solubility of materials within the solvent, safety and commercial aspects is undertaken.

Solutions are particularly advantageous, where possible, provided the solution has a sufficiently low viscosity to enable it to be handled. Preferably a concentration of from about 5% to about 50% and preferably from about 10% to about 25% by weight of the coating material in the solvent is used in order to reduce the drying/evaporation load after surface treatment has taken place. The treatment apparatus can be any of those normally used for this purpose, such as inclined rotary pans, rotary drums and fluidised beds.

In one highly preferred embodiment, the coating is applied to the cores either by fluid bed coating or fluid bed drying. The composite material blend (e.g. of the wax or wax-like substance (A) and the amphiphilic polymer (B)) is applied to the core units from either the molten state or from solvent solution. It is preferable to apply aqueous dispersions (e.g. via an emulsion) of the composite blend to the core allowing that annealing may potentially be necessary to coalesce the dispersion particles into a continuous film. Suitable plasticisers may also be employed to produce continuous films. The polymer is preferably applied to the core units as either a solution from solvent or from an emulsion or latex. In one embodiment, where the polymer is applied as an alkaline coating solution such as for the application of a pH responsive polymer, preferably the solution further comprises a stabilizer, for example, ammonia. Aqueous alkaline solutions of the polymer are prepared by neutralisation of the acidic latex. Neutralisation with volatile amines, such as ammonia, trimethyl amine, triethyl amine, ethanolamine and dimethylethanolamine, are preferred as the volatile component is readily lost and a robust polymer coating is readily achieved. Typically neutralisation is accompanied by clarification of the coating mixture, from an opaque latex to a clear or hazy solution, and an increase in viscosity. Additional solvent may be added to reduce the polymer concentration and solution viscosity and so obtain a solution suitable for further processing.

In one highly preferred embodiment, the coating is applied from a dispersion (e.g. emulsion) of the wax or wax-like substance (A) and the amphiphilic polymer (B) and other optional ingredients including surfactants, plasticisers, cosolvents, fillers etc.

There are a number of different methods known in the art for making dispersions from waxes/polymers which may be utilised for the manufacture of aqueous dispersions used in this invention. In order for a dispersion to be stable it is necessary to control the particle size of the dispersed hydrophobic phase (e.g. the wax or wax like substance and/or amphiphilic polymer phase) in order to ensure that the dispersed phase does not settle out of suspension. To achieve this it is typically necessary to carefully control the method of addition of the hydrophobic material or blend (i.e. non-aqueous phase) to the water (or visa-versa) in the presence of chemical dispersants and/or surfactants whilst applying sufficient agitation/mechanical sheer to break up the oil phase. This hydrophobic phase may comprise the wax or wax like substance (A) in the molten state and may also comprise a molten solution in combination with the amphiphilic polymer (B) (e.g. the dispersion is hot and so the dispersed phase exists within the dispersion as liquid droplets). This hydrophobic phase may alternatively comprise the wax or wax like substance (A) in the solid state and may also comprise a solid solution in combination with the amphiphilic polymer (e.g. the dispersion is cold, below the solidification point of the hydrophobic dispersed material and so will be a dispersion of solid particles). The amphiphilic polymer (B) may be self dispersing meaning it is able to facilitate its emulsification and stabilisation in the water phase. Alternatively, if the polymer is not readily dispersible then surfactants may be required to disperse the polymer; these may be mixed into the oil phase prior to dispersion or may be present in the water phase prior to dispersion. It may also be necessary to include a plasticiser within the dispersion formulation so as to improve the coherency of the film which is produced from the coated emulsion. Typically materials which are solvents for the hydrophobic phase, such as chlorinated solvents, terpenes, hydrogentated rosin derivatives, hydrocarbon solvents or other substances which have at least a small solubility in the hydrophobic phase, are suitable. It should be recognised that, in the case of the amphiphilic substance (B), it may be present in both phases of the dispersion as it will have compatibility in both the hydrophobic and hydrophilic portions of the dispersion.

Generally, methods for creating dispersions may be divided into two processes. In the first of these, often referred to as the ‘direct method’, the hydrophobic phase is added in a controlled manner to the stirred aqueous phase resulting in the formation of dispersed particles in the water. An alternative method for manufacturing the dispersion is the inversion method, in which the aqueous phase is added to the hydrophobic phase. Initially the product of this process is the forced formation of an emulsion of water in the hydrophobic phase, however upon continued addition of the aqueous phase the system inverts to a dispersion of the hydrophobic phase in water.

Surfactants may be used in the manufacture of a dispersion to stabilise the colloidal dispersion of hydrophobic phase in water. In a preferred embodiment, one or more surfactants are added to either the aqueous or hydrophobic phase or both. In the case of the aqueous phase, the surfactant is typically dissolved in water prior to use. When added to the hydrophobic phase, the surfactant may be dissolved in any solvent present or may, for instance, be dissolved or dispersed into the molten wax or wax like substance (A).

A wide range of surfactants may be used, including non-ionic, anionic or cationic or zwitteronic (amphoteric) structures. The identity and chemistry of the surfactant used to stabilise the system is preferably selected to avoid incompatibility with the final formulation media.

In one highly preferred embodiment of the invention, cationic surfactants are used. These help to stabilise the formation of a stable dispersion, but once the core particles have been coated with the dispersion and the coated particles are then suspended in, for example, a laundry product containing anionic surfactant, the interaction between the cationic surfactants in the coating and the anionic surfactants in the media leads to the formation of an extra layer of this neutralised material and an increase in the barrier properties of the coating.

Conversely, in an alternative preferred embodiment of the invention, anionic surfactants are used. These help to stabilise the formation of a stable dispersion, but once the core particles have been coated with the dispersion and the coated particles are then suspended in, for example, a laundry product containing cationic surfactant the interaction between the anionic surfactants in the coating and the cationic surfactants in the media leads to the formation of an extra layer of this neutralised material and an increase in the barrier properties of the coating.

Other water soluble materials which behave as emulsifiers, such as polyvinyl alcohol or other water soluble polymers and non-ionic surfactants, may be used so as to produce a stable dispersion having small dispersed droplet size. Polymeric surfactants may also be used.

The addition of surfactants and/or emulsifiers to stabilise the dispersion may result in the entrapment of air and subsequent foaming which can interfere with efficient manufacture of the dispersion. Thus, in one particularly preferred embodiment, an anti foaming agent is added to the aqueous and/or hydrophobic phase prior to dispersion manufacture in order to suppress the generation of foam.

In fluid bed coating the particulate core material is fluidised in a flow of hot air and the coating solution, melt, emulsion or latex sprayed onto the particles and dried, where the coating solution. Melt, emulsion or latex may be applied by top spray coating, bottom spray (Wurster) coating or tangential spray coating, where bottom spray (Wurster) coating is particularly effective in achieving a complete encapsulation of the core. In general, a small spray droplet size and a low viscosity spray medium promote uniform distribution of the coating over the particles.

In fluid bed drying the particulate core material is mixed with the coating solution, emulsion or latex and the resulting moist product introduced to the fluid bed dryer, where it is held in suspension in a flow of drying air, where it is dried or in the case of molten material is congealed. Such systems are available from several suppliers including GEA Process Engineering (Bochum, Germany) and Glatt Process Technology (Binzen, Germany).

It will be appreciated that any method which allows for the application of an essentially continuous film of material may be used to produce the layers described herein and that the processes described are illustrative and not exhaustive of methods, such as curtain coating, other forms of spray coating and any other suitable methods which is able to produce substantially the same particle layer structures described herein.

The results of the coating process are determined by the interaction of a combination of material and process parameters. In spray coating the following have been found to be important:
1. Composition and particle size distribution of the core.
2. The glass transition temperature of the polymer.
3. The solubility of materials within the chosen solvent.
4. Delivery of the composite blend of the wax or wax-like substance (A) and the amphiphilic polymer (B) as either a solution, dispersion or melt.
5. Delivery of the responsive polymer as either a solution, dispersion or a latex.
6. Delivery of primer and/or filler layers as either a solution, dispersion or a latex.
7. The solids content of the coating solution, dispersion, melt or latex.
8. The method of production of the emulsion such as the order of addition of the components and the chemical nature (cationic or anionic for example) of the components.
9. The dosing rate of the coating solution, dispersion, melt or latex to the fluidised bed.
10. The delivery of the coating solution, dispersion, melt or latex by bottom spray (Wurster) or top spray.
11. The mass of polymer applied per unit mass of the core.
12. The mass of the composite blend material applied per unit mass of the core.
13. The inlet temperature of the air maintaining the fluidised bed.
14. The difference between the polymer's glass transition temperature and inlet air temperature of the air flow maintaining the fluidised bed.

The present invention is further described by way of the following non-limiting examples.

### EXAMPLES

### Amphiphilic Graft Co-Polymer Synthesis Examples

### Synthesis Example 1

### Reaction of Polybutadiene-Graft-Maleic Anhydride Lithene N4-5000-5MA Grade with Jeffamine M2070 (Preparation of AGC1) in a Reaction Flask

PBD-g-MA (200 g, Polybutadiene-graft-maleic anhydride obtained from Synthomer, Lithene N4-5000-5MA grade) having an average molecular weight of approximately 5,750 Da was weighed out and added to a reaction flask with a 0.5 L capacity, equipped with an overhead stirrer. A flow of nitrogen gas was passed through the vessel, which was then heated to 150° C. using an oil bath. Stirring of the molten mixture then commenced and Jeffamine M2070 (Polyether monoamine) (144 g, purchased from Huntsman), having an average molecular weight of 2,000 Da was added over 45 minutes via a dropping funnel. The reaction mixture was maintained at 150° C. for a total of approximately 6 hours with stirring. Following this it was allowed to cool and was then dispensed into a glass container.

### Synthesis Example 2

### Reaction of Polybutadiene-Graft-Maleic Anhydride Lithene N4-5000-15MA Grade with Jeffamine M2070 (Preparation of AGC2) in a Reaction Flask

PBD-g-MA (200 g, Polybutadiene-graft-maleic anhydride obtained from Synthomer, Lithene N4-5000-15MA grade) having an average molecular weight of approximately 5,750 Da was weighed out and added to a reaction flask with a 1.0 L capacity, equipped with an overhead stirrer. A flow of nitrogen gas was passed through the vessel, which was then heated to 150° C. using an oil bath. Stirring of the molten mixture then commenced and Jeffamine M2070 (Polyether monoamine) (401.1 g, purchased from Huntsman), having an average molecular weight of 2,000 Da was added over 45 minutes through a dropping funnel. The reaction mixture was maintained at 150° C. for a total of approximately 6 hours with stirring. Following this it was allowed to cool and was then dispensed into a glass container.

### Synthesis Example 3

### Preparation for a 100 g Batch of Butyl Modified Mowiol 10-98 with 8% Butyraldehyde (PVB)

A 2-litre reaction vessel was charged with Mowiol 10-98 (100 g) and DI water (900 g). The reaction vessel was placed onto a heating block and fitted with a head unit, anchor stirrer, nitrogen line, condenser and bubbler. The mixture was then heated to 80° C. and stirred under nitrogen for 1 hour or until all Mowiol had dissolved. After this time, the temperature of the heating block was reduced to 60° C. and 2M HCl (13.4 mL, 27 mmol) was added followed by butyraldehyde (6.42 g, 89 mmol). The reaction was continued to stir at 60° C. external under an atmosphere of nitrogen for 4 hours. After this time the heating block was turned off and the mixture was stirred overnight under an atmosphere of nitrogen at room temperature. After this time, the reaction mixture was neutralised to pH 7 using dilute ammonia solution and the reaction product was precipitated by drop-wise addition of the reaction mixture to an excess of acetone (4 L total). The precipitate was then filtered off and dried in a vacuum oven at 40° C. overnight.

It is also possible to use the reaction mixture directly, optionally after neutralisation of the excess HCl with a suitable alkali such as sodium hydroxide. The reaction mixture may be diluted down to a suitable viscosity to enable, for example, spraying coating and further optional components may be added such as inorganic salts or surfactants or other as described herein.

### Formulation Example (1)

### Preparation of Coated Sodium Percarbonate Particles

### Materials

Samples of sodium percarbonate granules were sourced from two suppliers; Evonik Industries grade Q35 and Solvay Chemicals' grades—Oxyper S131 and Oxyper SHC.

### Sample SPC1

Particles of sodium percarbonate (grade S131) were sourced from Solvay. The particles were sieved so as to isolate the size fraction between 500-1000 microns. The particles were coated on a Mini-Glatt fluid bed dryer utilising a bottom coating (Wurster) method. The concentration of the feed was typically 5% solids contents. The typical temperature applied was 23-24° C. The airflow varied from 0.35 bar to 0.6 bar and the atomising pressure was kept to 0.03 bar. The feedstock was composed of a 1:1 mixture of Vybar 260 and Unithox 420 (both ex. Baker Petrolite) dissolved in chloroform to a total concentration of 5% which was fed by peristaltic pump; the flow rate varied from 5 to 7 g/min. A typical scale for this process was 100 g.

### Sample SPC2

Particles of sodium percarbonate (grade S131) were sourced from Solvay. The particles were sieved so as to isolate the size fraction between 500-1000 microns. The particles were coated on an Aeromatic Fielder Strea 1 fluid bed dryer utilising a bottom coating (Wurster) method. The feedstock was composed of a 1:1 mixture of Vybar 260 and Unithox 420 (both ex. Baker Petrolite) dissolved in chloroform to a total concentration of 5%. The concentration of the polymer feed was typically 5% solids content. The typical operating temperature varied from 30-42° C. The airflow was varied from 3 to 5% and the atomising pressure was kept at 0.5 bar. The polymer solution was fed using a peristaltic pump and the flow rate varied from 6 to 8 g/min. A typical scale for this process was 500 g.

### Formulation Example (2)

### Preparation of Coated PAP Particles

### Granulation Method

### (i) Preparation of Hydroxyethylmethacrylate-Co-Methylmethacrylate (HEMA) Copolymer (Granulation Binder)

Into a clean, dry reactor was added 544 g of 50% ethanol in water followed by the monomers—HEMA 159 g and MMA 41 g—washing these in with 136 g of 50% ethanol water solution. The reactor was then heated to 75° C. whilst stirring under a nitrogen atmosphere. Initiator (AZCVA 4.6 g) was then dissolved in 50% ethanol water mixture (120 g) to produce the ‘initiator solution’, adding dilute ammonia solution as required. On reaching desired temperature, Initiator Aliquot 1 (31.1 g of the initiator solution) was added. The reaction was then left to stir for 30 minutes, and then Initiator aliquot 2 (62 g of initiator solution) was added. The reaction was then left to stir for 3.5 hours after which time the reactor temperature was increased to 80° C. Once the reactor had reached temperature, Initiator Aliquot 3 (31.14 g of initiator solution) was added and reaction was stirred for a further 1 hour. The polymeric solution product was then removed from the reactor and left to cool.

### (ii) Preparation of Granulated PAP Core

The hydroxyethylmethacrylate-co-methylmethacrylate co-polymer prepared as above was used to produce a granulated form of PAP. WM1 powder (ex Solvay) was placed into a high sheer granulator. For small scale preparation a food processor equipped with mixing blades is suitable. To this was added, drop-wise, a solution of the HEMA-co-MMA which has been diluted down to 6% with 50% ethanol water solution whilst the powder is mixed at the highest mixing speed. For example, 300 g of WM1 PAP powder is placed into the high sheer mixer and a total of 200 g of 6% polymer solution is applied as the granulation binder. It is important not to add all the solution too quickly or all at once. From time to time the polymer solution addition is stopped part-way and the semi granulated powder is allowed to dry. After drying the semi granulated powder is placed back into the high sheer granulator and mixing and polymer solution addition is recommenced. After all the polymer solution has eventually been added the granules are removed from the mixer and allowed to dry in an unheated vacuum oven for 24 hrs. The dry granules are then sieved to isolate the size fraction falling between 500-1000 microns.

### (ii) PAP-A Sample Preparation

Particles of PAP prepared as in Example 2(ii) above were coated on a Mini-Glatt fluid bed dryer utilising a bottom spray Wurster′ arrangement.

The particles were fluidised within the chamber of the apparatus with a feed concentration of typically 5% solids. The feedstock was composed of a 1:1 mixture of Vybar 260 and Unithox 420 (both ex. Baker Petrolite) dissolved in chloroform to a total concentration of 5%. The typical temperature was 27-24° C. The airflow varied from 0.3 bar to 0.45 bar and the atomising pressure was kept at 0.03 bar. The polymer solution was fed by peristaltic pump and the flow rate varied from 4 to 6.5 g/min. A typical scale for this process was 100 g.

The benefit agent may be processed to form core particles. This may be via granulation, compaction, pelletizing or extrusion and spheronisation. The benefit agent may be mixed with fillers, binders or disintegrants, or a mixture thereof. The benefit agent may also be mixed with further optional ingredients as desired. Fillers are selected upon their ability to absorb and retain water in order to achieve the optimal rheological conditions for lubrication and surface plasticization required during extrusion and spheronisation. Details of suitable binders or fillers are described hereinabove.

For the extrusion-spheronisation method, it is preferable to mix water with the bleaching compound, filler, binder and chelating agent.

Example core particles were prepared comprising:
1. 6-phthalimidoperoxyhexanoic acid (PAP) as the bleach material obtained as Eureco™ WM1 from Solvay Chemicals and comprising 65-75% by weight active PAP.
2. Crosspovidone as the crosslined polyvinylpyrrolidone Kolloidon CL-M obtained from BASF.
3. A secondary alkyl sulfonate sodium salt as the Hostapur SAS obtained from Clariant.
4. The chelating agent etidronic acid obtained as the 60% solution from Sigma Aldrich.

| Raw Materials | % by Weight |
|---|---|
| 6-phthalimido peroxy hexanoic acid (PAP); | 81 |
| Eureco ™ WM1 | |
| Kolloidon CL-M | 7 |
| Hostapur SAS 93 | 9 |
| Etidronic acid (60%) | 3 |

The binder material is firstly dissolved into water, before adding to the bleach material, filler, binder, chelating agent and additional water (if required) by mixing in a Kenwood blender until a uniform wet mass is obtained.

The wet mass is then extruded through a mini-screw extruder, using a 0.7 mm holed die plate, available from Caleva Process Solutions at a rate of 50 rpm. The resultant extrudate is then fed into a multi bowl spheroniser 120 available from Caleva Process Solutions, running at a speed of 2000 rpm for approximately 1 minute, or sufficient time for the extrudate to have formed smooth spherical particles. The resultant particles are dried at 40° C. for 1 hour.

### Formulation Example (3)

### Stability Data—Sodium Percarbonate

Table 1 details the stability of Sample SPC1. Analysis was by thiosulfate titration against controls to determine the level of hydrogen peroxide remaining. In this test the particles coated as described in Example 1 above were added to a commercial laundry stain removal product (Vanish PowerShots), in this case a unit dose formulation. The particles of sample SPC1 were added at a concentration of 5% (based on the total weight of particle including active core and encapsulation coating). The total mass of the test sample was 20 g (including media and sample 106). The data shows the activity of the covered particles with respect to the content of the benefit agent (sodium percarbonate) after 3, 7 and 28 days of storage submerged in the commercial liquid formulation.

TABLE 1
Stability of Sodium Percarbonate in Sample SPC1
in Vanish PowerShots

| | Temp. | | Total | |
|---|---|---|---|---|
| | of Test | Age | Weight/Activity | |
| Media | (° C.) | (days) | Stability | Average |
| Vanish PowerShots | RT | 3.0 | 102.5% | 100.5% |
| Vanish PowerShots | RT | 3.0 | 101.2% | |
| Vanish PowerShots | RT | 3.0 | 98.5% | |
| Vanish PowerShots | 40 | 3.0 | 99.8% | 98.8% |
| Vanish PowerShots | 40 | 3.0 | 95.8% | |
| Vanish PowerShots | 40 | 3.0 | 97.8% | |
| Vanish PowerShots | RT | 7.0 | 100.4% | 98.9% |
| Vanish PowerShots | RT | 7.0 | 99.1% | |
| Vanish PowerShots | RT | 7.0 | 97.5% | |
| Vanish PowerShots | 40 | 7.0 | 100.2% | 96.9% |
| Vanish PowerShots | 40 | 7.0 | 97.5% | |
| Vanish PowerShots | 40 | 7.0 | 93.6% | |
| Vanish PowerShots | RT | 28.0 | 101.6% | 97.5% |
| Vanish PowerShots | RT | 28.0 | 93.3% | |
| Vanish PowerShots | 40 | 28.0 | 88.0% | 86.7% |
| Vanish PowerShots | 40 | 28.0 | 85.4% | |

Temp. = Temperature

Table 2 details the stability of sample SPC1. In this test the particles coated as described in Example 1 above were added to a commercial laundry cleaning product (Ariel Excel tablets), in this case a unit dose formulation. The particles of sample SPC1 were added at a concentration of 5% (based on the total weight of particle including active core and encapsulation coating). The total mass of the test sample was 20 g (including media and sample SPC 1). The data shows the activity of the covered particles with respect to the content of the benefit agent (sodium percarbonate) after 3, 7 and 28 days of storage submerged in the commercial liquid formulation.

TABLE 2
Stability of Sodium Percarbonate in Sample SPC1
in Aerial Excel Tablets

| | Temp. | | Total | |
|---|---|---|---|---|
| | of Test | Age | Weight/Activity | |
| Media | (° C.) | (Days) | Stability | Average |
| Ariel Excel tabs | RT | 3.0 | 98.7% | 99.6% |
| Ariel Excel tabs | RT | 3.0 | 98.7% | |
| Ariel Excel tabs | RT | 3.0 | 100.4% | |
| Ariel Excel tabs | 40 | 3.0 | 95.2% | 95.1% |
| Ariel Excel tabs | 40 | 3.0 | 93.5% | |
| Ariel Excel tabs | 40 | 3.0 | 95.1% | |
| Ariel Excel tabs | RT | 7.0 | 98.7% | 99.8% |
| Ariel Excel tabs | RT | 7.0 | 96.5% | |
| Ariel Excel tabs | RT | 7.0 | 100.9% | |
| Ariel Excel tabs | 40 | 7.0 | 94.8% | 91.1% |
| Ariel Excel tabs | 40 | 7.0 | 86.8% | |
| Ariel Excel tabs | 40 | 7.0 | 87.4% | |
| Ariel Excel tabs | RT | 28.0 | 89.7% | 90.4% |
| Ariel Excel tabs | RT | 28.0 | 91.2% | |
| Ariel Excel tabs | 40 | 28.0 | 61.2% | 63.8% |
| Ariel Excel tabs | 40 | 28.0 | 66.3% | |

Table 3 details the stability of sample SPC 1 in glycerol. In this test the particles coated as described in Example 1 above were added to glycerol so as to simulate a media which could be used in a unit dose formulation. The particles of sample SPC 1 were added at a concentration of 5% (based on the total weight of particle including active core and encapsulation coating). The total mass of the test sample was 20 g (including media and sample SPC 1). The data shows the activity of the covered particles with respect to the content of the benefit agent (sodium percarbonate) after 3, 7 and 28 days of storage submerged in glycerol.

TABLE 3
Stability of Sodium Percarbonate in Sample SPC1 in Glycerol

| | Temp. | | Total | |
|---|---|---|---|---|
| | of Test | Age | Weight/Activity | |
| Media | (° C.) | (Days) | Atability | Average |
| Glycerol | RT | 3.0 | 98.7% | 97.6% |
| Glycerol | RT | 3.0 | 96.5% | |
| Glycerol | 32 | 3.0 | 93.6% | 93.0% |
| Glycerol | 32 | 3.0 | 92.3% | |
| Glycerol | RT | 7.0 | 102.1% | 100.2% |
| Glycerol | RT | 7.0 | 98.2% | |
| Glycerol | 32 | 7.0 | 97.8% | 97.6% |
| Glycerol | 32 | 7.0 | 97.4% | |

Table 4 details the stability of Sample SPC2 in Vanish PowerShots. In this test the particles coated as described in Example 1 above were added to a commercial laundry stain removal product (Vanish PowerShots), in this case a unit dose formulation. The particles of sample SPC2 were added at a concentration of 5% (based on the total weight of particle including active core and encapsulation coating). The total mass of the test sample was 20 g (including media and sample SPC2). The data shows the activity of the covered particles with respect to the content of the benefit agent (sodium percarbonate) after 3, 7 and 28 days of storage submerged in the commercial liquid formulation.

TABLE 4
Stability of Sodium Percarbonate in Sample SPC2
in Vanish PowerShots

| | Temp. | | Total | |
|---|---|---|---|---|
| | of Test | Age | Weight/Activity | |
| Media | (° C.) | (Days) | Stability | Average |
| Vanish PowerShots | RT | 3.0 | 88.8% | 91.2% |
| Vanish PowerShots | RT | 3.0 | 91.1% | |
| Vanish PowerShots | RT | 3.0 | 93.5% | |
| Vanish PowerShots | 40 | 3.0 | 94.0% | 91.9% |
| Vanish PowerShots | 40 | 3.0 | 90.9% | |
| Vanish PowerShots | 40 | 3.0 | 89.8% | |
| Vanish PowerShots | RT | 7.0 | 87.9% | 87.8% |
| Vanish PowerShots | RT | 7.0 | 89.9% | |
| Vanish PowerShots | RT | 7.0 | 87.8% | |
| Vanish PowerShots | 40 | 7.0 | 86.6% | 87.5% |
| Vanish PowerShots | 40 | 7.0 | 88.2% | |
| Vanish PowerShots | 40 | 7.0 | 88.5% | |
| Vanish PowerShots | RT | 28.0 | 87.7% | 93.0% |
| Vanish PowerShots | RT | 28.0 | 98.4% | |
| Vanish PowerShots | 40 | 28.0 | 81.9% | 82.2% |
| Vanish PowerShots | 40 | 28.0 | 82.4% | |

Table 5 details the stability of sample SPC2 in Ariel Excel tablets. In this test the particles coated as described in Example 1 above were added to a commercial laundry cleaning product (Ariel Excel tablets), in this case a unit dose formulation. The particles of sample SPC2 were added at a concentration of 5% (based on the total weight of particle including active core and encapsulation coating). The total mass of the test sample was 20 g (including media and sample SPC2). The data shows the activity of the covered particles with respect to the content of the benefit agent (sodium percarbonate) after 3, 7 and 28 days of storage submerged in the commercial liquid formulation.

TABLE 5
Stability of Sodium Percarbonate in Sample SPC2
in Ariel Excel Tablets

| | Temp. | | Total | |
|---|---|---|---|---|
| | of Test | Age | Weight/Activity | |
| Media | (° C.) | (Days) | Stability | Average |
| Ariel Excel tabs | RT | 3.0 | 88.1% | 90.8% |
| Ariel Excel tabs | RT | 3.0 | 89.2% | |
| Ariel Excel tabs | RT | 3.0 | 93.5% | |
| Ariel Excel tabs | 40 | 3.0 | 90.8% | 91.9% |
| Ariel Excel tabs | 40 | 3.0 | 87.3% | |
| Ariel Excel tabs | 40 | 3.0 | 92.9% | |
| Ariel Excel tabs | RT | 7.0 | 93.1% | 92.3% |
| Ariel Excel tabs | RT | 7.0 | 91.3% | |
| Ariel Excel tabs | RT | 7.0 | 91.5% | |
| Ariel Excel tabs | 40 | 7.0 | 88.0% | 85.4% |
| Ariel Excel tabs | 40 | 7.0 | 88.6% | |
| Ariel Excel tabs | 40 | 7.0 | 82.8% | |
| Ariel Excel tabs | RT | 28.0 | 89.3% | 88.2% |
| Ariel Excel tabs | RT | 28.0 | 87.1% | |
| Ariel Excel tabs | 40 | 28.0 | 66.8% | 66.6% |
| Ariel Excel tabs | 40 | 28.0 | 66.3% | |

Table 6 details the stability of sample SPC2 in glycerol. In this test the particles coated as described in Example 1 above were added to glycerol so as to simulate a media which could be used in a unit dose formulation. The particles of sample SPC2 were added at a concentration of 5% (based on the total weight of particle including active core and encapsulation coating). The total mass of the test sample was 20 g (including media and sample SPC 2). The data shows the activity of the covered particles with respect to the content of the benefit agent (sodium percarbonate) after 3, 7 and 28 days of storage submerged in glycerol.

TABLE 6
Stability of Sodium Percarbonate in Sample SPC2 in Glycerol

| | Temp. | | Total | |
|---|---|---|---|---|
| | of Test | Age | Weight/Activity | |
| Media | (° C.) | (Days) | Stability | Average |
| Glycerol | RT | 3.0 | 89.2% | 91.3% |
| Glycerol | RT | 3.0 | 93.3% | |
| Glycerol | 32 | 3.0 | 90.4% | 90.8% |
| Glycerol | 32 | 3.0 | 91.2% | |
| Glycerol | RT | 7.0 | 91.9% | 91.7% |
| Glycerol | RT | 7.0 | 91.4% | |
| Glycerol | 32 | 7.0 | 91.8% | 91.3% |
| Glycerol | 32 | 7.0 | 90.7% | |

### Stability Data for Encapsulated PAP Particles

Table 7 details the stability of sample PAP-A. In this test the particles coated as described in Example 2 above were added to glycerol so as to simulate a media which could be used in a unit dose formulation. The particles of sample PAP-A were added at a concentration of 5% (based on the total weight of particle including active core and encapsulation coating). The total mass of the test sample was 20 g (including media and sample PAP-A). The data shows the activity of the covered particles with respect to the content of the benefit agent (sodium percarbonate) after 3 and 7 days of storage submerged in glycerol. A control sample of uncoated PAP powder (grade WM1 ex Solvay was also tested under the same conditions).

TABLE 7
Stability of Sample PAP-A

| | | Temp. of | Age | |
|---|---|---|---|---|
| Sample | Media | Test (° C.) | (Days) | Activity |
| PAP - A | Glycerol | RT | 3.0 | 97.0% |
| PAP - A | Glycerol | RT | 7.0 | 96.1% |
| PAP - A | Glycerol | 32 | 3.0 | 98.2% |
| PAP - A | Glycerol | 32 | 7.0 | 100.5% |
| Control - untreated | Glycerol | RT | 3.0 | 36.5% |
| PAP (Grade WM1 | | | | |
| ex Solvay) | | | | |
| Control - untreated | Glycerol | 32 | 3.0 | 35.1% |
| PAP (Grade WM1 | | | | |
| ex Solvay) | | | | |

PAP cores (see Example 2 for preparation method) encapsulated with a selection of coatings were mixed into dry laundry powder (ASDA brand—colour formulation). 0.2 g of PAP (sample weights were adjusted to compensate for slight differences in coating weights relative to PAP core content) was placed in 10 g of washing powder. The powder samples were placed into an incubator held at 32° C. and at 60% relative humidity for the time periods noted in the table below.

TABLE 8
Stability of PAP-A in Dry Laundry Powder

| | | Test | Age | |
|---|---|---|---|---|
| Sample | Media | Conditions | (Days) | Activity |
| PAP powder | Laundry | 32° C./60% RH | 7.0 | 83.1% |
| granulated with | Powder | | | |
| HEMA-MMA | | | | |
| (ex. 9(1)) | | | | |
| PAP-A | Laundry | 32° C./60% RH | 7.0 | 83.7% |
| | Powder | | | |
| Control - | Laundry | 32° C./60% RH | 7.0 | 21.2% |
| untreated PAP | Powder | | | |
| (Grade WM1 ex | | | | |
| Solvay) | | | | |

### Formulation Example (4)

### Sodium Percarbonate Coated Cores

In this example the sodium percarbonate cores were coated with a blend of Vybar 260 (ex. Baker Hughes) and an amphiphilic graft co-polymer.

The amphiphilic co-polymer is composed of a polybutadiene backbone (ex. Synthomer: Lithene N4-5000-5MA) which has been grafted with Jeffamine M2070 (ex. Huntsman) with a MA:Graft ratio of 1:0.75 (see Synthetic Example 1 above). This amphiphilic graft co-polymer produced as above was labelled AGC3.

By weight, a blend containing 10% AGC3:90% Vybar 260 by adding appropriate weights of each to a suitable solvent, for example chloroform. This solution, at around 5% solids content, was coated onto sodium percarbonate cores using the method as described in example (1) above (with the replacement of Unithox with AGC3 at the required percentage) to produce coated sample SPC3.

### Formulation Example (5)

### Stability of Sample SPC3: Sodium Percarbonate Cores Coated with 3 (10%):Vybar260

Table 9 details the stability of sample SPC3 in Vanish PowerShots. In this test the particles coated as described in Example 1 (with the replacement of Unithox with AGC3 at the required percentage) above were added to a commercial laundry stain removal product (Vanish PowerShots), in this case a unit dose formulation. The particles of sample SPC3 were added at a concentration of 5% (based on the total weight of particle including active core and encapsulation coating). The total mass of the test sample was 20 g (including media and sample SPC3). The data shows the activity of the covered particles with respect to the content of the benefit agent (sodium percarbonate) after 3, 7 and 28 days of storage submerged in the commercial liquid formulation.

TABLE 9
Stability of Sodium Percarbonate in
Sample SPC3 in Vanish PowerShots

| | | | Total |
|---|---|---|---|
| | Temp. of | Age | Weight/Activity |
| Media | Test (° C.) | (Days) | Stability |
| Vanish PowerShots | RT | 3.0 | 99.0% |
| Vanish PowerShots | 40 | 3.0 | 96.7% |
| Vanish PowerShots | RT | 7.0 | 97.5% |
| Vanish PowerShots | 40 | 7.0 | 97.5% |
| Vanish PowerShots | RT | 28.0 | 99.4% |
| Vanish PowerShots | 40 | 28.0 | 90.9% |

Table 10 details the stability of sample SPC3 in Ariel Excel tablets. In this test the particles coated as described in Example 1 above (with the replacement of Unithox with AGC3 at the required percentage) were added to a commercial laundry cleaning product (Ariel Excel tablets), in this case a unit dose formulation. The particles of sample SPC3 were added at a concentration of 5% (based on the total weight of particle including active core and encapsulation coating). The total mass of the test sample was 20 g (including media and sample SPC3). The data shows the activity of the covered particles with respect to the content of the benefit agent (sodium percarbonate) after 3, 7 and 28 days of storage submerged in the commercial liquid formulation.

TABLE 10
Stability of Sodium Percarbonate in
Sample SPC3 in Ariel Excel Tablets

| | | | Total |
|---|---|---|---|
| | Temp. of | Age | Weight/Activity |
| Media | Test (° C.) | (Days) | Stability |
| Ariel Excel tabs | RT | 3.0 | 101.6% |
| Ariel Excel tabs | 40 | 3.0 | 100.6% |
| Ariel Excel tabs | RT | 7.0 | 98.2% |
| Ariel Excel tabs | 40 | 7.0 | 94.8% |
| Ariel Excel tabs | RT | 28.0 | 97.1% |
| Ariel Excel tabs | 40 | 28.0 | 83.9% |

### Release Data

### Formulation Example (6)

### (i) Release of Hydrogen Peroxide from Sample SPC1

General method: 0.1 g of coated sodium percarbonate was placed into 30 mL of a pre-heated simulated wash liquor (10 g Tesco non-bio laundry liquid dissolved in 20 g water) and the liquid is stirred at ˜200 revolutions per minute using a 2.5 cm triangular magnetic follower. Peroxide release is measured using hydrogen peroxide sensitive ‘Quantofix dip strips’ manufactured by Machery-Nagel, Germany.

TABLE 11
Release of Hydrogen Peroxide from Sample SPC1

| | | PPM hydrogen | | |
|---|---|---|---|---|
| | Time | peroxide | Temp. of Test | % |
| Coating Blend | (min) | released | (° C.) | Release |
| 50% Vybar260:50% | 0 | 0 | 30 | 0 |
| Unithox420 | 10 | 1 | | 0.1 |
| (Sample SPC1) | 15 | 7 | | 0.9 |
| | 20 | 30 | | 3.8 |
| | 30 | 150 | | 18.8 |
| | 40 | 300 | | 37.5 |
| | 50 | 500 | | 62.5 |

### (ii) Release of Hydrogen Peroxide from Sample SPC3

See general method above—Example 6(1).

TABLE 12
Release of Hydrogen Peroxide from Sample SPC3

| | | PPM Hydrogen | | |
|---|---|---|---|---|
| | Time | Peroxide | Temp. of Test | % |
| Coating Blend | (min) | Released | (° C.) | Release |
| 90% Vybar260:10% | 3 | 0 | 30 | 0 |
| AGC3 | 5 | 50 | | 6.3 |
| | 6 | 50 | | 6.3 |
| | 7 | 150 | | 18.8 |
| | 9 | 225 | | 28.1 |
| | 12 | 300 | | 37.5 |
| | 15 | 300 | | 37.5 |
| | 20 | 500 | | 62.5 |
| | 25 | 650 | | 81.3 |
| | 30 | 800 | | 100 |

### (iii) Release of Hydrogen Peroxide from a Sample which Contains 35% of AGC3 and 65% Vybar260

See general method above—Example 6(1).

TABLE 13

| | | PPM Hydrogen | | |
|---|---|---|---|---|
| | Time | Peroxide | Temp. of Test | % |
| Coating Blend | (min) | Released | (° C.) | Release |
| Vybar260:AGC3 | 1 | 67.5 | 30 | 8.4 |
| (65:35) | 2 | 400 | | 50 |
| | 5 | 800 | | 100 |

### Example (7)

### Application of Coating from Emulsion

In this example the sodium percarbonate cores were coated with a blend of Vybar 260 (manufactured by Baker Hughes) and an amphiphilic graft co-polymer. The amphiphilic co-polymer is composed of a polybutadiene backbone (manufactured by. Synthomer: Lithene N4-5000-15MA) which has been grafted with Jeffamine M2070 (manufactured by. Huntsman) with a MA:Graft ratio of 1:0.75 (see Synthetic Example 2 above). This amphiphilic graft co-polymer produced as above was labelled AGC2.

An emulsion of Vybar 260 and Jeffamine M2070 grafted Lithene N4-5000-15MA was produced using the following method. A dispersion was prepared as follows. 1.5 g of AGC2 were dissolved in 190 g of DI water while stirring. 8.5 g of Vybar 260 were added to the solution. The solution was heated to 65° C. for approximately 20 minutes while stirring or until the Vybar was completely molten. The warm mixture was then sonicated with a sonic probe for up to 10 minutes, creating an emulsion. The emulsion was cooled immediately on an ice/water bath swirling the emulsion occasionally. The emulsion was stirred throughout the spray coating process (coating process as described above for solvent based solutions).

TABLE 14
Stability of Sodium Percarbonate Particles Coated with Emulsion

| | | | Total |
|---|---|---|---|
| | Temp. of | Age | Weight/Activity |
| Media | Test (° C.) | (Days) | Stability |
| Ariel Excel tabs | RT | 3.0 | 80.3% |
| Ariel Excel tabs | RT | 7.0 | 61.3% |

TABLE 15
Stability of Sodium Percarbonate Particles coated with Emulsion

| | | | Total |
|---|---|---|---|
| | Temp. of | Age | Weight/Activity |
| Media | Test (° C.) | (Days) | Stability |
| Vanish Powershots | RT | 3.0 | 90.6% |
| Vanish Powershots | RT | 7.0 | 84.7% |

### Release of Peroxide in Simulated Wash

In this experiment the release of peroxide was measured using peroxide sensitive dip-strips-‘Quantofix’ brand. To one litre of wash liquor containing 5 g of Tesco non-bio liquid laundry detergent was added 0.25 g of the coated particles. The particle containing wash liquor was then placed into a Tergotometer ‘pot’ (United States Testing Co. Inc. Tergotometer model 7243S) and the instrument set to agitate the liquid at 150 cycles per minute. The release of peroxide was measured at suitable intervals. The data is presented below in Table 16.

TABLE 16
Release of Peroxide in Simulated Wash

| | | PPM Hydrogen | | |
|---|---|---|---|---|
| | Time | Peroxide | Temp. of Test | % |
| Coating Blend | (min) | Released | (° C.) | Release |
| AGC2 | 1 | 3 | 40 | 5 |
| | 2 | 10 | | 17 |
| | 3 | 30 | | 50 |
| | 4 | 60 | | 100 |

In this example the sodium percarbonate cores were coated with a blend of Vybar 260 (ex. Baker Hughes), Mowiol 3-85 (Kuraray) and an amphiphilic graft co-polymer. The amphiphilic co-polymer is composed of a polybutadiene backbone (ex. Synthomer: Lithene N4-5000-5MA) which has been grafted with Jeffamine M2070 (ex. Huntsman) with a MA:Graft ratio of 1:0.75 (see Synthetic Example 2 above). This amphiphilic graft co-polymer produced as above was labelled AGC1. In this experiment a plasticiser in the form of tetrachloroethylene was also incorporated into the prepared emulsion.

An emulsion of Vybar 260, Mowiol 3-85, tetrachloroethylene and Jeffamine M2070 grafted Lithene N4-5000-5MA was produced using the following method. 1 g of Mowiol 3-85 was dissolved in 190 g of water while stirring and heating. The solution was allowed to cool down to room temperature. 0.1 g of tetrachlorethylene and 1.5 g of AGC1 were added to the solution. Once the AGC was dissolved completely, 8.5 g of Vybar 260 was added. The mixture was heated to 65° C. for approximately 20 min while stirring or until the Vybar was completely molten. The warm mixture was then sonicated with a sonic probe for up to 10 min, creating an emulsion. The emulsion was cooled immediately on an ice/water bath swirling the emulsion occasionally. The emulsion was stirred throughout the spray coating process. Spray coating was conducted as described above for the solvent based solutions.

TABLE 17
Stability of Sodium Percarbonate Particles Coated with Emulsion

| | | | Total |
|---|---|---|---|
| | Temp. of | Age | Weight/Activity |
| Media | Test (° C.) | (Days) | Stability |
| Ariel Excel tabs | RT | 3.0 | 71.1% |
| Ariel Excel tabs | RT | 7.0 | 54.1% |

TABLE 18
Stability of Sodium Percarbonate Particles Coated with Emulsion

| | | | Total |
|---|---|---|---|
| | Temp. of | Age | Weight/Activity |
| Media | Test (° C.) | (Days) | Stability |
| Vanish Powershots | RT | 3.0 | 83.0% |
| Vanish Powershots | RT | 7.0 | 82.6% |

### Release of Peroxide in Simulated Wash

In this experiment the release of peroxide was measured using peroxide sensitive dip-strips—‘Quantofix’ brand. To one litre of wash liquor containing 5 g of Tesco non-bio liquid laundry detergent was added 0.25 g of the coated particles. The particle containing wash liquor was then placed into a Tergotometer ‘pot’ (United States Testing Co. Inc. Tergotometer model 7243S) and the instrument set to agitate the liquid at 150 cycles per minute. The release of peroxide was measured at suitable intervals. The data is presented below.

TABLE 19
Release of Peroxide in Simulated Wash

| | | PPM Hydrogen | | |
|---|---|---|---|---|
| | Time | Peroxide | Temp. of Test | % |
| Coating Blend | (min) | released | (° C.) | Release |
| AGC1 | 1 | 10 | 40 | 17 |
| | 2 | 30 | | 50 |
| | 3 | 60 | | 100 |

### Example (8)

### (i) High Solids Emulsion Method

68 g of Vybar 260 wax were melted in a suitable beaker at 70° C. To this, 12 g of an amphiphilic graft co-polymer (see Synthesis Examples 1 (using Lithene N4-5000-5MA) or 2 (using Lithene N4-5000-15MA)) were added to the beaker containing the molten wax. 140 g of water was heated to 100° C. in a separate metal beaker. The water was stirred using a Silverson L4R mixer at speed setting 5. The molten wax/polymer mixture was added over a 10 minutes period. 140 g of cold water was the added to the emulsion with stirring and the emulsion was crash cooled in a water bath of ice and stirred continuously.

### (ii) Particle Coating

Sodium Percarbonate Cores Coated with Wax/Amphiphilic Graft Copolymer Via High Solids Emulsion (Sample SPC-E):

The emulsion as prepared above in Example (8(i)) was coated onto particle cores using a fluid bed coater as described, for example, in Formulation Examples 1 and 2, vide supra, using the emulsion feedstock in place of the solvent chloroform based feedstock. The emulsion feedstock was let-down′ with water and stirring to form a feedstock having about 5% solids content prior to spraying and the emulsion was continuously stirred during the spray coating process.

### (iii) Further Layer of Coating with Butyl-Modified PVOH(PVB). (Sample SPC-E-Pvb)

To previously wax/amphiphilic graft copolymer coated sodium percarbonate particles (e.g. SPC-E) as produced using Example 8(ii) a further coat of butyl modified PVOH may be added (see Synthesis Example 3 for general method of PVB preparation). A feedstock containing about 5% solids modified PVB was prepared and coated onto particles previously coated with wax/amphiphilic copolymer using the method described above in order to produce coated particles having, in this case, two coating layers.

TABLE 20

| | | Wax-Amphiphilic Graft Copolymer | | | | |
|---|---|---|---|---|---|---|
| | | Coating Composition | | | | Coating Level |
| | | AGC1 | AGC2 | Wax | Coating Level - | ‘PVOH’ |
| Sample ID | Core | content (%) | Content (%) | content (%) | Wax (%)* | Polymer (%)* |
| PVB 1 | Q35 | 15 | — | 85 | 18.8 | 1.4 (PVOH) |
| PVB 2 | Q35 | 15 | — | 85 | 18.8 | 5.2 (PVB) |
| PVB 3 | Q35 | 15 | — | 85 | 15.9 | 4.6 (PVB) |
| PVB 4 | S131 | 15 | — | 85 | 19.8 | 1.0 (PVOH) |
| PVB 5 | Q35 | — | 15 | 85 | 10.5 | 5.0 (PVB) |
| PVB 6 | Q35 | 15 | — | 85 | 16.2 | 4.8 (PVB) |
| PVB 7 | SHC | 15 | — | 85 | 17.4 | 1.1 (PVB) |
| PVB 8 | S131 | — | 15 | 85 | 14.5 | 5.4 (PVB) |
| PVB 9 | S131 | — | 15 | 85 | 14.5 | 7.8 (PVB) |

*Percentage coating level represents an increase by the given percentage on the mass taken prior to coating.

### Example (9)

### Exotherm Control Coating—Measurement of Exotherm Reduction

Coated samples of sodium percarbonate particles were produced which were coated, as described by the method given above in Example 7 (sample Exo 1). This sample serves as a control sample having no exotherm control layer. Samples were then further coated with modified PVOH(PVB), as described in example 8(iii)) to produce sample Exo 2 with the exception of sample Exo 4 where the coating process was reversed—this sample has an initial coating of PVOH(PVB) with a wax/amphilphilic graft copolymer coating on top. Sample Exo 3 does not have a wax/amphiphilic graft co-polymer coating—it has only a modified PVOH(PVB) coating. Table 21 shows the differential scanning calorimetry (DSC) data for these samples. It can be clearly seen that samples Exo 2 and Exo 4 show much reduced exotherm in comparison to Exo 1 as a result of the presence of modified PVOH(PVB). Sample Exo 3 clearly shows that the presence of modified PVOH(PVB) only as a coating on the particle does not give rise to an exotherm.

TABLE 21
Thermal Testing Results

| | | | | Exo 4 |
|---|---|---|---|---|
| Sample | | | | (PVB 1^{st} |
| Number | Exo 1 | | Exo 3 | coat/Wax |
| (Description | (Wax | Exo 2 | (PVB | 2^{nd} on |
| of Coating) | Only) | (Wax/PVB) | Only) | Top) |
| Coating level | No PVB | 5% | 5% | 5% |
| PVB | coating | | | |
| Coating level | 20% | 20% | None | 20% |
| wax | | | | |
| Core SPC- | Q35 | Q35 | Q35 | Q35 |
| Evonik Q35 | | | | |
| integration of | 569 | 177 | 4 | 66 |
| exotherm | | | | |
| peak (J/g) by | | | | |
| DSC | | | | |

Wax = Vybar 260 supplied by Baker Hughes

Table 22 presents the stability for a range of coated particles. 0.2 g of coated sodium percarbonate particles were immersed in commercial liquid laundry product in small vials (˜2 mL volume) and stored either at room temperature or at 40° C. for the times stated after which the percentage level of remaining hydrogen peroxide (based on the initial levels present) was determined by titration.

TABLE 22
Stability Data for Sodium Percarbonate coated with Wax/AGC + Further
Butyl Modified PVOH Layer

| | | % Peroxide Activity | | | % Peroxide Activity | | |
|---|---|---|---|---|---|---|---|
| | | Remaining | | | Remaining | | |
| | | Vanish Powershots | | | Ariel Laundry Liquid | | |
| | | Stain Boost | | | Tabs | | |
| | Coated | 7 | | 28 | 7 | | 28 |
| Coating Type & | SPC Ref | days | 7 days | days | days | 7 days | days |
| Composition | Number | RT | 40° C. | RT | RT | 40° C. | RT |
| Wax + AGC 1 + | PVBSPC 1 | 91.3 | 67.5 | 69. | 89.0 | 43.7 | 63.9 |
| Mowiol 10-98 (Q35) | | | | | | | |
| Wax + AGC 1 + PVB | PVBSPC 2 | 95.1 | 69.1 | 76.0 | 89.7 | 62.0 | 75.2 |
| on top (Q35) | | | | | | | |
| PVB as primer + Wax + | PVBSPC 3 | 93.6 | 75.7 | 73.7 | 86.8 | 60.0 | 61.7 |
| AGC 1 on top | | | | | | | |
| (Q35) | | | | | | | |
| Wax + AGC 1 + | PVBSPC 4 | 87.8 | 52.9 | 70.6 | 90.9 | 58.7 | 71.4 |
| Mowiol PVOH 30-98 | | | | | | | |
| top coat (S131) | | | | | | | |
| Wax + AGC (15MA; | PVBSPC 5 | 77.1 | 33.6 | 43.0 | 73.4 | 40.0 | 20.8 |
| DS = 0.25) + PVB | | | | | | | |
| (Q35) | | | | | | | |
| Wax + AGC 1 + PVB | PVBSPC 6 | 92.9 | 64.4 | 58.3 | 90.8 | 53.9 | 54.4 |
| (Q35) | | | | | | | |
| Wax + AGC 1 + | PVBSPC 7 | 72.6 | 25.2 | 43.4 | 77.1 | 27.7 | 40.5 |
| PVB (SHC) | | | | | | | |
| Wax + AGC 2 + PVB | PVBSPC 8 | 94.2 | 47.9 | 74.9 | 91.9 | 52.5 | 70.1 |
| (S131) | | | | | | | |

N.B. AGC 1 and AGC 2 differ in the level of maleinisation (i.e. Synthomer Lithene N4-5000-5MA or Lithene N4-5000-15MA) of the backbone prior to the grafting reaction with Jeffamine (i.e. Jeffamine M2070) to produce the amphiphilllic graft copolymer.
DS refers to the degree of substitution of Jeffamine in relation to the maleic acid functionality - e.g. 0.25 means 25% of the maleic acid groups are reacted with Jeffamine.
PVB refers to 8% butyraldyde modified Mowiol 10-98 synthesised as described in Synthesis Example 3.
Wax is Vybar 260 supplied by Baker Hughes.
Q35 refers to the sodium percarbonate grade produced by Evonik,
SHC and S131 refer to grades of sodium percarbonate produced by Solvay.

Various modifications and variations of the described aspects of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the relevant fields are intended to be within the scope of the following claims.

1. A composite comprising:
(i) one or more core units comprising at least one benefit agent; and
(ii) a coating on said one or more core units, wherein said coating comprises a blend comprising:
(A) at least one wax or wax-like substance; and
(B) at least one amphiphilic polymer.

2. A composite according to claim 1 wherein the coating further comprises one or more additional ingredients selected from a plasticiser, an exotherm control agent, a cosolvent, a wetting agent, a compatabiliser, a filler, a dispersant, an inorganic material and an emulsifier.

3. A composite according to claim 1 wherein the wax is a natural wax selected from beeswax, candelilla wax, carnauba wax, a paraffin wax, ozokerite wax, ceresine wax, montan wax, terpenes, camphor and mixtures thereof.

4. A composite according to claim 1 wherein the wax is a synthetic, linear or branched wax selected from a petroleum-derived microcrystalline wax, a polyolefin wax and a polyethylene-derived wax, and mixtures thereof.

5. A composite according to claim 2 wherein the exotherm control agent is a homopolymer or copolymer of vinyl alcohol.

6. A composite according to claim 2 wherein the exotherm control agent is a modified polyvinyl alcohol.

7. A composite according to claim 2 wherein the exotherm control agent is a copolymer of vinyl alcohol and an olefin.

8. A composite according to claim 2 wherein the exotherm control agent is a copolymer of vinyl alcohol and an acrylic or methacrylic monomer.

9. A composite according to claim 2 wherein the exotherm control agent is butyraldehyde modified PVOH (PVB).

10. A composite according to claim 1 wherein the composite comprises one or more additional coating layers on the one or more core units.

11. A composite according to claim 10 wherein the additional coating layer is a primer layer, a filler layer, a layer of an inorganic material, an adhesion promoting layer or a de-tacifying layer.

12. A composite according to claim 10 wherein the additional coating layer is a responsive polymer.

13. A composite according to claim 12 wherein the responsive polymer is a responsive material having acid or ethoxylated functionality.

14. A composite according to claim 12 wherein the responsive polymer is responsive to a change in surfactant concentration.

15. A composite according to claim 12 wherein the responsive polymer is responsive to ionic strength change.

16. A composite according to claim 12 wherein the responsive polymer is responsive to a concentration change.

17. A composite according to claim 12 wherein the responsive polymer is insoluble at pH values below its pKₐ value, and soluble at pH values at or above its pKₐ value.

18. A composite according to claim 12 wherein the responsive polymer is insoluble at high ionic strength and soluble at low ionic strength values.

19. A composite according to claim 1 wherein the responsive polymer is insoluble in concentrated product formulations and soluble in conditions whereby the solute is at low concentration post dilution.

20. A composite according to claim 1 which comprises an additional layer comprising an exotherm control agent.

21. A composite according to claim 20 wherein the exotherm control agent is a homopolymer or copolymer of vinyl alcohol, a modified polyvinyl alcohol, a copolymer of vinyl alcohol and an olefin, a copolymer of vinyl alcohol and an acrylic or methacrylic monomer, or butyraldehyde modified PVOH (PVB).

22. A composite according to claim 1 wherein the benefit agent is selected from a bleach, a bleach activating agent, a preformed per-acid, a bleach booster, a diacyl peroxide, a hydrogen peroxide source, a metal catalyst or pro-catalyst, an enzyme, a drug, a pro-drug, a vitamin, a pro-vitamin, an essential oil, a fish oil, a lubricant, a flavour and a fragrance.

23. A composite according to claim 1 wherein the amphiphilic polymer is a graft copolymer comprising a hydrophobic straight or branched chain carbon-carbon backbone having at least one hydrophilic side chain attached thereto.

24. A composite according to claim 23 wherein the hydrophilic side chains of the graft copolymer are each independently of formula (I), 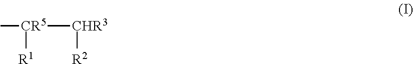
wherein R¹ and R² are each independently H, —C(O)WR⁴ or —C(O)Q; provided that at least one of R¹ and R² is the group —C(O)Q;
or R¹ and R² together form a cyclic structure together with the carbon atoms to which they are attached, of formula (II) 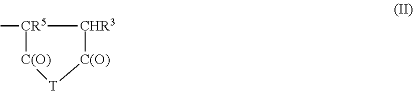
wherein:
R³ and R⁵ are each independently H or alkyl;
W is O or NR⁴;
Q is a group of formula —X¹—Y—X²P;
T is a group of formula —N—Y—X²—P;
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group.

25. A composite according to claim 24 wherein the hydrophilic polymeric group Y is of formula -(Alk¹-O)_{b}-(Alk²-O)_{c}—, wherein Alk¹ and Alk² are each independently an alkylene group having from 2 to 4 carbon atoms, and b and c are each independently an integer from 1 to 125; provided that the sum b+c has a value in the range of from about 10 to about 250.

26. A composite according to claim 23 wherein the graft copolymer has from 1 to 5000 pendant hydrophilic groups attached thereto.

27. A composite according to claim 23 wherein the carbon-carbon polymer backbone is derived from a homopolymer of an ethylenically-unsaturated polymerizable hydrocarbon monomer or from a copolymer of two or more ethylenically-unsaturated polymerizable hydrocarbon monomers.

28. A composite according to claim 26 wherein the copolymer comprises a carbon-carbon backbone onto which maleic anhydride or maleic anhydride acid/ester groups have been grafted.

29. A composite according to claim 23 wherein the carbon-carbon polymer backbone is polybutadiene-graft-maleic anhydride and the hydrophilic side chains of the graft are prepared from a side chain precursor of formula (VIc), 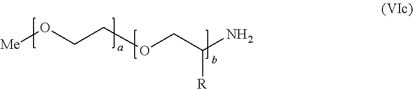
wherein R is H or alkyl, and the sum of a and b is an integer from 5 to 250.

30. A composite according to claim 23 wherein the carbon-carbon backbone is a copolymer of:
(i) maleic anhydride, maleic acid or salts thereof or maleic acid ester or salts thereof or a mixture thereof; and
(ii) one or more ethylenically-unsaturated polymerizable monomers.

31. A composite according to claim 1 wherein the amphiphilic polymer is a block copolymer of ethylene and ethylene oxide.

32. A process for preparing a composite according to claim 1, said process comprising applying to one or more core units a coating comprising a blend comprising:
(A) at least one wax; and
(B) at least one amphiphilic polymer.

33. A process according to claim 32 which further comprises applying one or more additional layers to the one or more core units.

34. A process according to claim 33 wherein the additional layer is a responsive polymer, a responsive material having acid or ethoxylated functionality, responsive to a change in surfactant concentration, responsive to ionic strength change, responsive to a concentration change, insoluble at pH values below its pKₐ value, and soluble at pH values at or aboves its pKₐ value, insoluble at pH values belows its pKₐ value, and soluble at pH values at or above its pKₐ value, insoluble at high ionic strength and soluble at low ionic strength values, or insoluble in concentrated product formulations and soluble in conditions whereby the solute is at low concentration post dilution.

35. A consumer product comprising a composite according to claim 1.

36. A consumer product according to claim 35 which is selected from laundry products, dishwash products, personal care and cosmetic formulations, surface cleaning formulations, pharmaceutical, veterinary, food, vitamin, mineral and nutritional compositions.

37. (canceled)

38. A method of preparing a laundry product, said method comprising admixing a composite according to claim 1 with one or more conventional laundry product components.

39. (canceled)

40. A composite according to claim 1 wherein:
the benefit agent is sodium percarbonate;
the coating comprises a blend of from about 60 to about 90% wax and from about 10 to about 40% of the amphiphilic polymer;
the wax is a polyolefin polymer; and
the amphiphilic copolymer comprises a polybutadiene backbone and pendant hydrophilic grafts attached thereto, wherein each hydrophilic graft is derived from an NH₂ functionalised ethylene oxide and propylene oxide copolymer.

41. A composite according to claim 40, wherein the coating further comprises a plasticiser, and wherein plasticiser is present in an amount of from about 0.1 to about 10% based on the weight of the total coating.
